(19) United States
(12) Patent Application Publication
(10) Pub. No.: US 2025/0206300 A1
(43) Pub. Date: Jun. 26, 2025

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventor: Taku YAMAZAKI, Tokyo (JP)

(21) Appl. No.: 18/975,323

(22) Filed: Dec. 10, 2024

(30) Foreign Application Priority Data
Dec. 26, 2023 (JP) 2023-219950

(51) Int. Cl. B60W 30/095; B60W 50/00; B60W 50/14; H04W 4/46

(52) U.S. Cl. CPC B60W 30/0956; B60W 50/0097; B60W 50/14; H04W 4/46; B60W 2050/143; B60W 2050/146; B60W 2520/10; B60W 2520/14; B60W 2554/4041; B60W 2554/4042; B60W 2554/4044; B60W 2554/80; B60W 2556/20; B60W 2556/65

(57) ABSTRACT

A driving assistance device is configured to predict a possibility of collision between a self-vehicle and a peripheral vehicle based on self-vehicle information and the peripheral vehicle information and notify an occupant of the self-vehicle based on a prediction result. In a case where a risk position is not included within a predetermined distance in a traveling direction of the self-vehicle, the device determines predicted tracks of the self-vehicle and the peripheral vehicle based on the self-vehicle information and the peripheral vehicle information, determines an evaluation distance for evaluating an approach situation between the self-vehicle and the peripheral vehicle based on the predicted tracks, and predicts that there is no possibility of collision between the self-vehicle and the peripheral vehicle when the evaluation distance is not included in a predetermined range.

### CROSS-REFERENCE TO RELATED APPLICATION(S)

This application claims priority to and the benefit of Japanese Patent Application No. 2023-219950, filed Dec. 26, 2023, the entire disclosure of which is incorporated herein by reference.

### BACKGROUND OF THE INVENTION

### Field of the Invention

The present invention relates to a driving assistance device, a driving assistance method, and a storage medium.

### Description of the Related Art

In recent years, efforts to provide access to sustainable transportation systems in consideration of vulnerable road users among traffic participants have been gaining momentum. In order to realize this, research and development for further improving traffic safety and convenience is focused on research and development related to preventive safety techniques. There is known a device that performs driving assistance for preventing a collision with another vehicle (peripheral vehicle) or the like without using map information. Japanese Patent No. 7054636 discloses a driving assistance device that registers, in a storage unit, position information of an intersection where a traveling track of a self-vehicle and a traveling track of another vehicle intersect, and performs driving assistance of the self-vehicle when the self-vehicle passes through the intersection again. The driving assistance device can identify a risk position where a self-vehicle may collide with another vehicle based on a traveling track of the self-vehicle and a traveling track of another vehicle, and can use the risk position for driving assistance. However, even when there is actually an intersection in the traveling direction of the self-vehicle, driving assistance using the risk position cannot be performed unless the intersection is identified as the risk position.

### SUMMARY OF THE INVENTION

According to some aspects of the present disclosure, an advantageous technique for appropriately performing driving assistance of a self-vehicle is provided. Accordingly, the present disclosure contributes to development of a sustainable transportation system. According to some embodiments, a driving assistance device comprising: a storage unit configured to store risk position information indicating a risk position where there is a possibility that a self-vehicle mounted with the driving assistance device will collide with another vehicle; an acquisition unit configured to acquire peripheral vehicle information indicating a vehicle speed, a position, a traveling track, and a yaw rate of a peripheral vehicle existing around the self-vehicle from the peripheral vehicle by vehicle-to-vehicle communication; a prediction unit configured to predict a possibility of collision between the self-vehicle and the peripheral vehicle based on self-vehicle information indicating a vehicle speed, a position, a traveling track, and a yaw rate of the self-vehicle and the peripheral vehicle information; and a notification unit configured to notify an occupant of the self-vehicle based on a prediction result by the prediction unit, wherein in a case where the risk position is not included within a predetermined distance in a traveling direction of the self-vehicle, the prediction unit determines a predicted track of the self-vehicle based on the self-vehicle information, and determines a predicted track of the peripheral vehicle based on the peripheral vehicle information, the prediction unit determines an evaluation distance for evaluating an approach situation between the self-vehicle and the peripheral vehicle based on the predicted track of the self-vehicle and the predicted track of the peripheral vehicle, and the prediction unit predicts that there is no possibility of collision between the self-vehicle and the peripheral vehicle when the evaluation distance is not included in a predetermined range is provided.

### BRIEF DESCRIPTION OF THE DRAWINGS

FIG. 1 is a block diagram for describing a configuration example of a vehicle according to some embodiments;

FIG. 2 is a diagram for describing an example of risk position information according to some embodiments;

FIGS. 3A and 3B are schematic diagrams for describing an example of a track intersection according to some embodiments;

FIG. 4 is a flowchart for describing an example of a method of registering a peripheral vehicle according to some embodiments;

FIG. 5 is a flowchart for describing an example of a method of determining a risk position according to some embodiments;

FIG. 6 is a schematic diagram for describing an example of a range including a peripheral vehicle according to some embodiments;

FIG. 7 is a flowchart for describing an example of a driving assistance operation related to a peripheral vehicle located on the side according to some embodiments;

FIG. 8 is a schematic diagram for describing an example of an evaluation distance determination operation related to a peripheral vehicle located on the side according to some embodiments;

FIG. 9 is a diagram for describing an example of a correspondence table of yaw angular acceleration and reliability according to some embodiments;

FIGS. 10A to 10C are schematic diagrams for describing an example of an evaluation distance determination operation related to a peripheral vehicle located on the side according to some embodiments;

FIGS. 11A and 11B are schematic diagrams for describing an example of a driving assistance operation related to a peripheral vehicle located on the side according to some embodiments;

FIG. 12 is a schematic diagram for describing an example of a driving assistance operation related to a peripheral vehicle located on the side according to some embodiments;

FIG. 13 is a flowchart for describing an example of a driving assistance operation related to a peripheral vehicle located ahead according to some embodiments;

FIG. 14 is a schematic diagram for describing an example of an evaluation distance determination operation related to a peripheral vehicle located ahead according to some embodiments;

FIGS. 15A to 15C are schematic diagrams for describing an example of an evaluation distance determination operation related to a peripheral vehicle located ahead according to some embodiments;

FIG. 16 is a schematic diagram for describing an example of a driving assistance operation related to a peripheral vehicle located ahead according to some embodiments;

FIG. 17 is a schematic diagram for describing an example of a method of determining a peripheral vehicle to be determined according to some embodiments; and

FIG. 18 is a schematic diagram for describing an example of a notification method according to some embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Vehicle Configuration Example

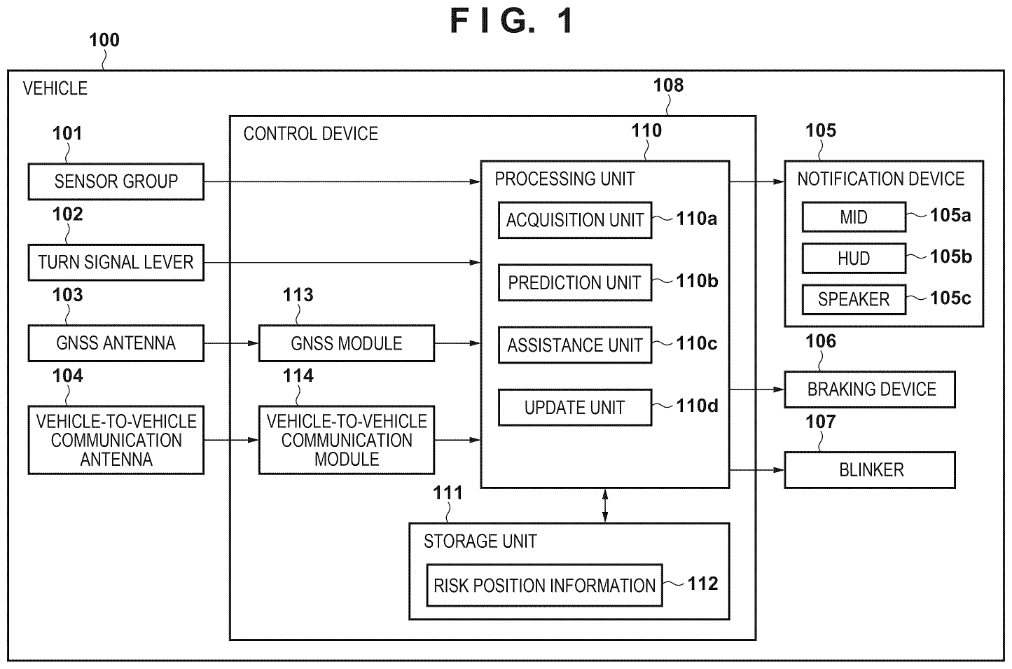

A configuration example of a vehicle 100 according to some embodiments will be described with reference to FIG. 1. As illustrated in FIG. 1, the vehicle 100 may include a sensor group 101, a turn signal lever 102, a global navigation satellite system (GNSS) antenna 103, a vehicle-to-vehicle communication antenna 104, a notification device 105, a braking device 106, a blinker 107, and a control device 108. Although FIG. 1 illustrates components referred to in the following description, the vehicle 100 may include other components for operating as a vehicle, such as a driving device and a transmission. Additionally or alternatively, the vehicle 100 may not include some of the components illustrated in FIG. 1. The vehicle 100 may be a four-wheeled vehicle, a two-wheeled vehicle, or another type of vehicle. Hereinafter, a driver of the vehicle 100 may be simply referred to as a driver.

The control device 108 controls the overall operation of the vehicle 100. As described later, the control device 108 performs driving assistance of the vehicle 100 on which the control device 108 is mounted. Therefore, the control device 108 may be referred to as a driving assistance device. The driving assistance provided by the control device 108 may be collision prevention assistance for preventing (reducing) a collision with another vehicle. In some embodiments, the control device 108 is capable of performing the collision prevention assistance without using map information. In the following description, the vehicle 100 may be referred to as a self-vehicle 100 to facilitate distinction from other vehicles. In addition, a vehicle different from the vehicle 100 may be referred to as another vehicle. Among other vehicles, a vehicle that currently exists around the self-vehicle 100 may be referred to as a peripheral vehicle. The peripheral vehicle may be a vehicle that can currently perform vehicle-to-vehicle communication with the self-vehicle 100.

The sensor group 101 includes various sensors for performing the driving assistance of the vehicle 100. For example, the sensor group 101 can include a speed sensor that detects the speed of the vehicle 100, an acceleration sensor that detects the acceleration of the vehicle 100, and the like. In addition, the sensor group 101 may include an outside detection sensor such as a camera capable of detecting an object around the vehicle 100, a millimeter wave radar, or a light detection and ranging (LIDAR). The sensor group 101 may include a sensor for measuring a yaw rate (yaw angle) of the vehicle 100. The sensor group 101 outputs the detection result to the control device 108.

The turn signal lever 102 is an operator for receiving an operation of changing an indication state of the blinker 107 (which may also be referred to as a direction indicator) from the driver. The indication state of the blinker 107 may include a state of indicating the right side of the vehicle 100, a state of indicating the left side of the vehicle 100, and a state of not indicating any side. The control device 108 switches the indication state of the blinker 107 in accordance with the operation of the turn signal lever 102 by the driver. The blinker 107 may be located on both the right and left sides of the vehicle 100. For example, when the driver operates the turn signal lever 102 to indicate the right side, the control device 108 causes the blinker 107 on the right side of the vehicle 100 to blink. When the driver operates the turn signal lever 102 to indicate the left side, the control device 108 causes the blinker 107 on the left side of the vehicle 100 to blink. When the driver operates the turn signal lever 102 so as not to indicate any direction, the control device 108 turns off the blinkers 107 on both sides of the vehicle 100. The control device 108 may change the indication state of the blinker 107 without depending on the operation of the turn signal lever 102 by the driver. For example, the control device 108 may turn off the blinking blinker 107 in response to the end of turning of the vehicle 100.

The GNSS antenna 103 receives a radio wave for location measurement transmitted from a GNSS satellite. For example, the GNSS antenna 103 can be used to acquire information regarding the current position and/or the traveling track (traveling history) of the vehicle 100. The vehicle-to-vehicle communication antenna 104 is an antenna that transmits and receives various types of data to and from peripheral vehicles. For example, the vehicle-to-vehicle communication antenna 104 can be used to acquire information regarding the current position, speed, and traveling track of a peripheral vehicle.

The notification device 105 is a device that notifies an occupant (for example, a driver) of the vehicle 100. In a case where the vehicle 100 may collide with a peripheral vehicle, the control device 108 can notify the occupant of the vehicle 100 of the possibility of collision with the peripheral vehicle by the notification device 105 as driving assistance. The notification device 105 may include a multi-information display (MID) 105a, a head-up display (HUD) 105b, and a speaker 105c. The MID 105a is a display device for displaying visual information for the occupant. For example, the MID 105a may display information indicating the possibility of collision with another vehicle. The HUD 105b is a display device for displaying visual information for the occupant. For example, the HUD 105b may display information indicating the possibility of collision with another vehicle. The MID 105a and the HUD 105b may be provided at different positions of the vehicle 100. For example, the MID 105a may be provided on a meter panel of the vehicle 100, and the HUD 105b may be provided on a windshield of the vehicle 100. The speaker 105c is an acoustic device for outputting voice information for the occupant. For example, the speaker 105c may output a voice or a notification sound indicating the possibility of collision with another vehicle.

The braking device 106 is a device, such as a brake, for performing a braking operation of the vehicle 100. In a case where the vehicle 100 may collide with a peripheral vehicle, as driving assistance, the control device 108 can perform deceleration assistance of the vehicle 100 by operating the braking device 106, thereby avoiding a collision with the peripheral vehicle.

The control device 108 is a device (computer) that controls the vehicle 100, and can include, for example, an electric control unit (ECU). The control device 108 can perform driving assistance by vehicle-to-vehicle communication with another vehicle and processing in the vehicle 100. For example, the control device 108 can perform driving assistance without using map information. The control device 108 includes a processing unit 110, a storage unit 111, a GNSS module 113, and a vehicle-to-vehicle communication module 114, which are connected to each other by a bus (not illustrated).

The processing unit 110 is a processor represented by a central processing unit (CPU), and executes a program stored in the storage unit 111. The storage unit 111 includes, for example, a random access memory (RAM), a read only memory (ROM), a hard disk, and the like, and stores a program (driving assistance program) for the processing unit 110 to perform driving assistance processing of the vehicle 100, a program (learning program) for the processing unit 110 to learn a risk position, various data, and the like. The storage unit 111 may store risk position information 112 created based on an intersection of a traveling track of the vehicle 100 and a traveling track of another vehicle. The risk position information 112 may include a plurality of risk positions. The risk position may be a position where the vehicle 100 may collide with another vehicle or a position where the possibility of collision is high. The risk position information 112 may be managed as a database.

The GNSS module 113 receives position information and the like of the vehicle 100 from the GNSS satellite via the GNSS antenna 103. In addition, the vehicle-to-vehicle communication module 114 receives various types of information from another vehicle via the vehicle-to-vehicle communication antenna 104.

The processing unit 110 can include an acquisition unit 110a, a prediction unit 110b, an assistance unit 110c, and an update unit 110d to perform driving assistance (collision prevention assistance in some embodiments) of the vehicle 100. Note that the processing unit 110 is not limited to the configuration including the units 110a to 110d. Another unit may be added or some units may be omitted depending on the type of driving assistance performed by the vehicle 100.

The acquisition unit 110a acquires peripheral vehicle information indicating a current position, a vehicle speed, a traveling track, and a blinker indication state of a peripheral vehicle that exists around the vehicle 100 from the peripheral vehicle via the vehicle-to-vehicle communication antenna 104 (vehicle-to-vehicle communication module 114). The peripheral vehicle information may explicitly or implicitly represent the current position, the vehicle speed, the traveling track, the blinker indication state, and the yaw rate of the peripheral vehicle. For example, the peripheral vehicle information may include the vehicle speed as it is, or may include information for calculating the vehicle speed (two current and previous geographical positions and their positioning times). In addition, the peripheral vehicle information may include a yaw rate as it is, or may include information for calculating the yaw rate (current and previous traveling directions of the peripheral vehicle). The acquisition unit 110a may acquire self-vehicle information indicating a current position, a speed, a traveling track, an indication state of a blinker 107, and a yaw rate of the vehicle 100 via the sensor group 101 and the GNSS antenna 103 (GNSS module 113). The acquisition unit 110a may acquire the indication state of the blinker 107 from the blinker 107, or may store the latest change command to the blinker 107 and acquire the indication state based on the stored change command.

The prediction unit 110b predicts a possibility that the vehicle 100 collides with another vehicle based on the self-vehicle information and the peripheral vehicle information acquired by the acquisition unit 110a. The prediction unit 110b may set a determination region and predict a possibility that the vehicle 100 collides with another vehicle in the determination region. In addition, the prediction unit 110b may perform driving assistance of the vehicle 100 based on the risk position information 112. For example, in a case where at least one risk position among a plurality of risk positions included in the risk position information 112 is located near the self-vehicle, the prediction unit 110b may set the determination region so as to include the risk position.

The assistance unit 110c performs driving assistance (collision prevention assistance) for the self-vehicle 100 based on a prediction result by the prediction unit 110b. In some embodiments, the assistance unit 110c can perform, as driving assistance of the vehicle 100, at least one of notification to an occupant of the vehicle 100 by the notification device 105 and deceleration assistance of the vehicle 100 by the braking device 106. The deceleration assistance may include assisting to decelerate until the self-vehicle 100 stops, that is, a stop assistance. The stop assistance may include not only deceleration of the self-vehicle 100 but also determination of a stop position of the self-vehicle 100, a route plan for the stop position, and automatic steering along the route.

The update unit 110d identifies an intersection of a traveling track of the vehicle 100 and a traveling track of the peripheral vehicle. The intersection of the traveling track of the vehicle 100 and the traveling track of the peripheral vehicle is hereinafter referred to as a track intersection. There may be a road intersection near the track intersection. In addition, the update unit 110d updates the risk position information 112 stored in the storage unit 111 based on the identified track intersection. For example, the update unit 110d may update the risk position information 112 by adding the track intersection to the risk position information 112. Alternatively or additionally, the update unit 110d may update the risk position information 112 by correcting any risk position included in the risk position information 112 based on the track intersection.

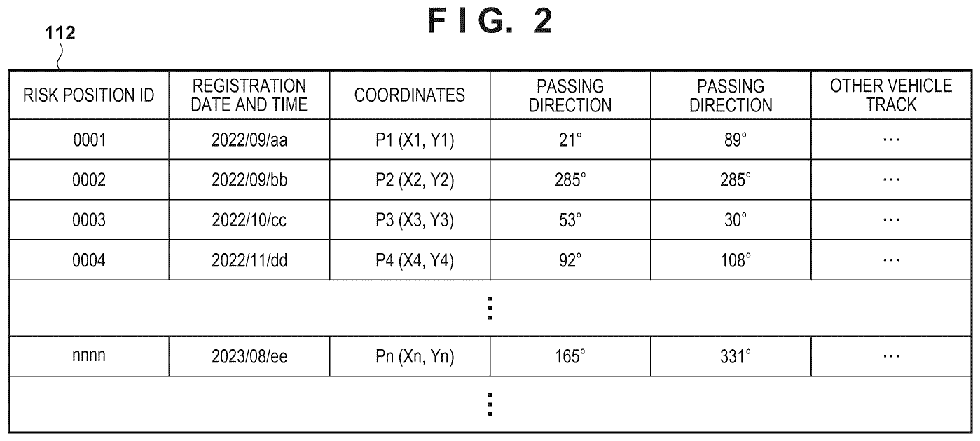

Subsequently, an example of the risk position information 112 will be described with reference to FIG. 2. In the example of FIG. 2, the risk position information 112 is described in a table format, but the risk position information 112 may be described in another format. The risk position information 112 has a record for each risk position. The column of the risk position information 112 illustrated in FIG. 2 is an example. The risk position information 112 may include other columns or may not include a part of the columns illustrated in FIG. 2.

The risk position information 112 may include information regarding a risk position ID, a registration date and time, coordinates, and a passing direction for each risk position. The risk position ID is a number for uniquely identifying the risk position. The registration date and time is a date and time when the risk position is registered in the risk position information 112. The coordinates are data for identifying the risk position, and are represented by, for example, latitude and longitude data. In addition to the latitude and longitude data, the coordinates may include altitude data such as elevation. The passing direction is a direction (direction, angle) in which the vehicle 100 faces when passing through the track intersection used to determine the risk position. The passing direction may be understood as a traveling direction (entering direction) of the vehicle 100 when entering the track intersection. In the example of FIG. 2, the passing direction of the vehicle 100 is prescribed with the north direction as 0°, the east direction as 90°, the south direction as 180°, and the west direction as 270°.

An intersection angle is an intersection angle of the traveling track of the self-vehicle 100 and the traveling track of another vehicle at the track intersection used to determine the risk position. The intersection angle may be a rotation angle of a traveling direction vector of another vehicle at the track intersection with respect to a traveling direction vector of the self-vehicle 100 at the track intersection. In this case, the intersection angle indicates in which direction another vehicle intersects with the traveling track of the self-vehicle. Another vehicle track is a traveling track of another vehicle passing through the track intersection used to determine the risk position.

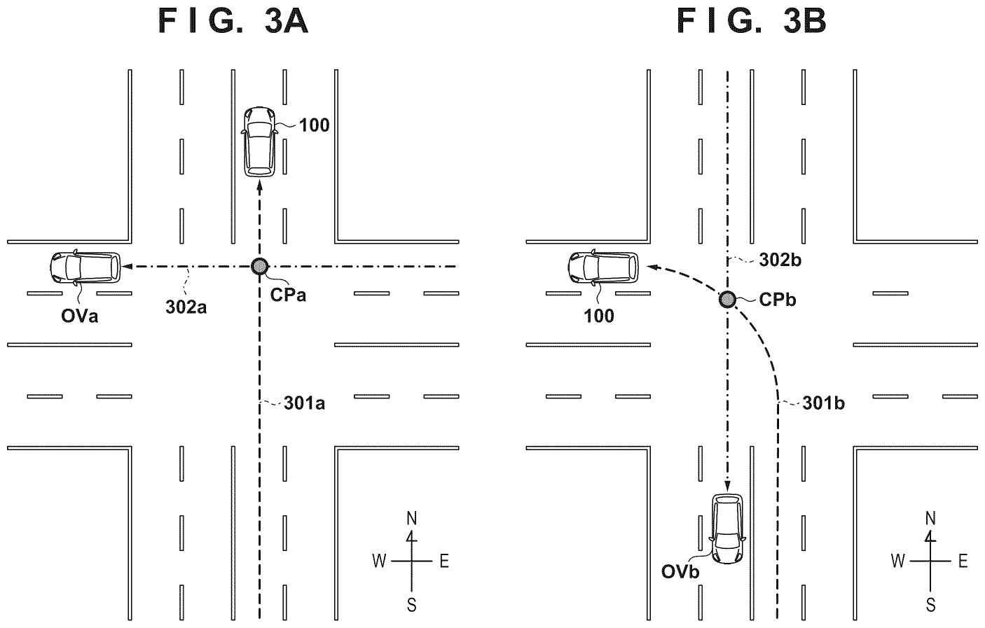

Subsequently, an example of the track intersection will be described with reference to FIGS. 3A and 3B. As described above, the track intersection is an intersection of a traveling track of the vehicle 100 and a traveling track of another vehicle. In the present specification, a case will be described in which the vehicle 100 is located in a region where right-hand traffic is mandatory. In this case, out of the left side and the right side, the side of a road on which passage is mandatory in the region where the vehicle 100 is located is the right side, and the opposite side is the left side. The opposite lane side of the vehicle 100 is the left side of the vehicle 100. The embodiment described in the present specification is also applicable to a case in which the vehicle 100 is located in a region where left-hand traffic is mandatory. In this case, the left and right sides (for example, a right turn and a left turn of the vehicle 100 or another vehicle, and a right side and a left side of a blinker indication state) in the processing described below are interchanged. Specifically, out of the left side and the right side, the side of the road on which passage is mandatory in the region where the vehicle 100 is located is the left side, and the opposite side is the right side. The opposite lane side of the vehicle 100 is the right side of the vehicle 100.

In the example illustrated in FIG. 3A, a position where a traveling track 301a of the self-vehicle 100 traveling straight in the north direction and a traveling track 302a of another vehicle OVa traveling straight in the west direction intersect is a track intersection CPa. Since timing (time) at which the self-vehicle 100 passes through the track intersection CPa and timing (time) at which another vehicle OVa passes through the track intersection CPa are different from each other, no collision occurs between the self-vehicle 100 and another vehicle OVa. In addition, the traveling track 301a of the self-vehicle 100 is included in the self-vehicle information acquired by the acquisition unit 110a via the sensor group 101 and the GNSS antenna 103 (GNSS module 113). The traveling track 302a of another vehicle OVa is included in another vehicle information acquired by the acquisition unit 110a via the vehicle-to-vehicle communication antenna 104 (vehicle-to-vehicle communication module 114). Since another vehicle OVa at the time of the acquisition is a peripheral vehicle that exists around the self-vehicle 100, another vehicle information may be understood as peripheral vehicle information.

In the example illustrated in FIG. 3B, a position where a traveling track 301b of the self-vehicle 100 traveling straight in the north direction and turning left, and a traveling track 302b of another vehicle OVb traveling straight in the south direction intersect is a track intersection CPb. Note that, since timing (time) at which the self-vehicle 100 passes through the track intersection CPb and timing (time) at which another vehicle OVb passes through the track intersection CPb are different from each other, no collision occurs between the self-vehicle 100 and another vehicle OVb. In addition, similarly to the traveling track 301a, the traveling track 301b of the self-vehicle 100 is included in the self-vehicle information acquired by the acquisition unit 110a via the sensor group 101 and the GNSS antenna 103 (GNSS module 113). Similarly to the traveling track 302a, the traveling track 302b of another vehicle OVb is included in another vehicle information (peripheral vehicle information) acquired by the acquisition unit 110a via the vehicle-to-vehicle communication antenna 104 (vehicle-to-vehicle communication module 114).

The function of the control device 108 can be realized by both hardware and software. For example, the function of the control device 108 may be realized by the processing unit 110 (CPU) performing the driving assistance program and/or the learning program as described above, or may be realized by an integrated circuit such as a programmable logic device (PLD) or an application specific integrated circuit (ASIC). In addition, in the example of FIG. 1, although the control device 108 is illustrated as a single element, the control device 108 may be divided into two or more elements as necessary.

### Management Processing of Peripheral Vehicle

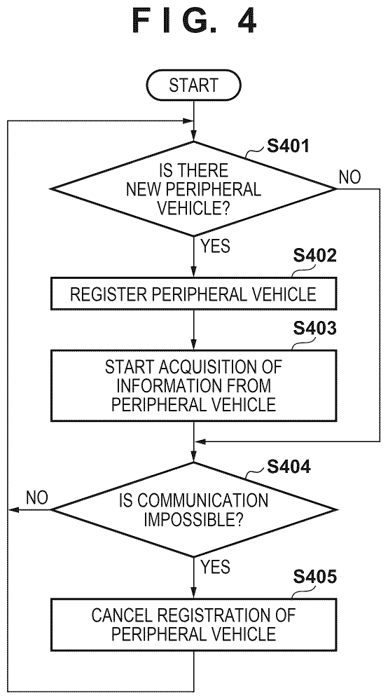

An example of processing of managing the peripheral vehicle will be described with reference to FIG. 4. The processing illustrated in the flowchart of FIG. 4 is performed by the processing unit 110 according to the learning program read from the storage unit 111. The processing in FIG. 4 may be started, for example, in response to the ignition of the vehicle 100 being turned on. The processing in FIG. 4 can be repeatedly performed until the ignition of the vehicle 100 is turned off.

In step S401, the processing unit 110 (for example, the acquisition unit 110a thereof) determines whether or not another vehicle exists around the self-vehicle 100. In a case where it is determined that another vehicle exists around the self-vehicle 100, the processing unit 110 shifts the processing to step S402, and shifts the processing to step S404 in other cases. For example, in a case where vehicle-to-vehicle communication can be performed via the vehicle-to-vehicle communication antenna 104 (vehicle-to-vehicle communication module 114), the processing unit 110 may determine that another vehicle exists around the self-vehicle 100.

In step S402, the processing unit 110 (for example, the acquisition unit 110a thereof) registers another vehicle found in step S401 as the peripheral vehicle. For example, the storage unit 111 may store a list of peripheral vehicles, and the processing unit 110 may add information of the found peripheral vehicle to this list. As will be described later, the peripheral vehicle is a target of a determination as to the possibility of collision. Instead of managing information of peripheral vehicles in a list, information may be acquired from all other vehicles capable of vehicle-to-vehicle communication at the start of each cycle in processing that is repeatedly executed, and the information acquired in this cycle may be discarded at the end of each cycle.

In step S403, the processing unit 110 (for example, the acquisition unit 110a thereof) starts acquisition of peripheral vehicle information from the peripheral vehicle by the vehicle-to-vehicle communication. As described above, the peripheral vehicle information may represent the vehicle speed, the position, and the traveling track of the peripheral vehicle. After starting the acquisition of the peripheral vehicle information in step S403, the processing unit 110 periodically (for example, every 100 ms) repeatedly acquires the peripheral vehicle information until the vehicle-to-vehicle communication with the peripheral vehicle can no longer be performed.

After the start of the acquisition of the peripheral vehicle information, in step S404, the processing unit 110 (for example, the acquisition unit 110a thereof) determines whether or not a vehicle that cannot perform the vehicle-to-vehicle communication exists among one or more registered peripheral vehicles. In a case where such a vehicle exists, the processing unit 110 shifts the processing to step S405, and shifts the processing to step S401 in other cases. For example, in a case where the peripheral vehicle is out of a communication range of the vehicle-to-vehicle communication or a power supply of the peripheral vehicle is turned off, the vehicle 100 cannot perform the vehicle-to-vehicle communication with the peripheral vehicle.

In step S405, the processing unit 110 (for example, the acquisition unit 110a thereof) cancels the registration of the peripheral vehicle that cannot perform the vehicle-to-vehicle communication. In other words, the processing unit 110 does not treat the vehicle that cannot perform the vehicle-to-vehicle communication as the peripheral vehicle. For example, the processing unit 110 deletes, from the list of peripheral vehicles stored in the storage unit 111, information regarding the peripheral vehicle that cannot perform the vehicle-to-vehicle communication.

As described above, by performing the processing of FIG. 4, the processing unit 110 can periodically acquire the latest peripheral vehicle information from another vehicle (that is, the peripheral vehicle) around the self-vehicle 100.

### Driving Assistance Processing

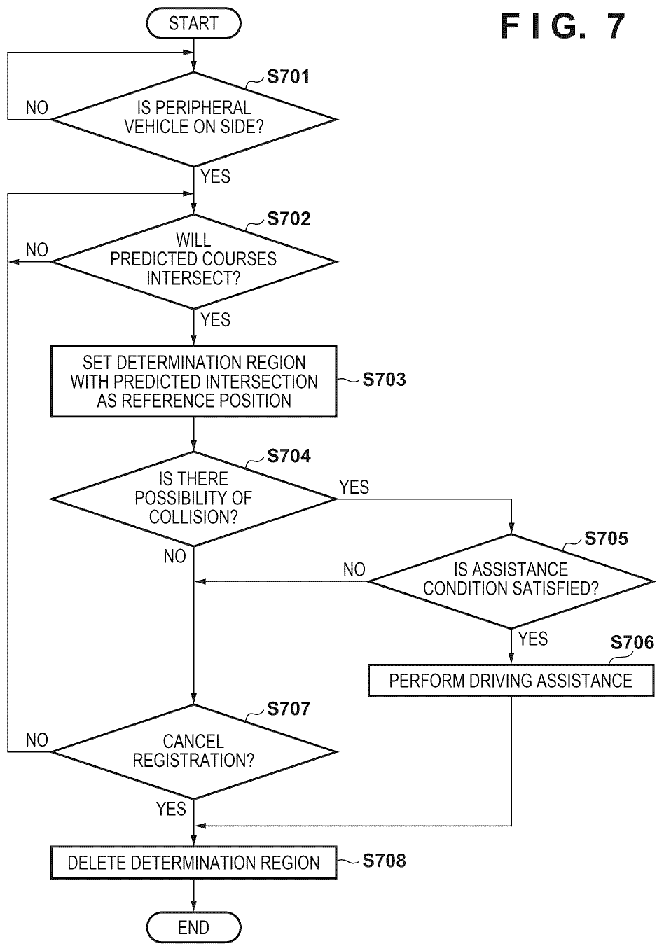

Driving assistance processing of some embodiments will be described with reference to FIGS. 6 to 18. As described with reference to FIG. 3A, when both the self-vehicle 100 and another vehicle travel straight in a case where another vehicle is included in the range on the side of the self-vehicle 100, these vehicles may collide with each other. On the other hand, as described with reference to FIG. 3B, when the self-vehicle 100 turns left and another vehicle travels straight in a case where another vehicle is included in the range ahead of the self-vehicle 100, these vehicles may collide with each other. As described above, depending on the position of another vehicle with respect to the self-vehicle 100, the situation where these vehicles may collide with each other can vary. Therefore, in some embodiments, the control device 108 performs separate driving assistance according to whether a peripheral vehicle exists within the range ahead of the self-vehicle 100 or within the range on the side of the self-vehicle 100.

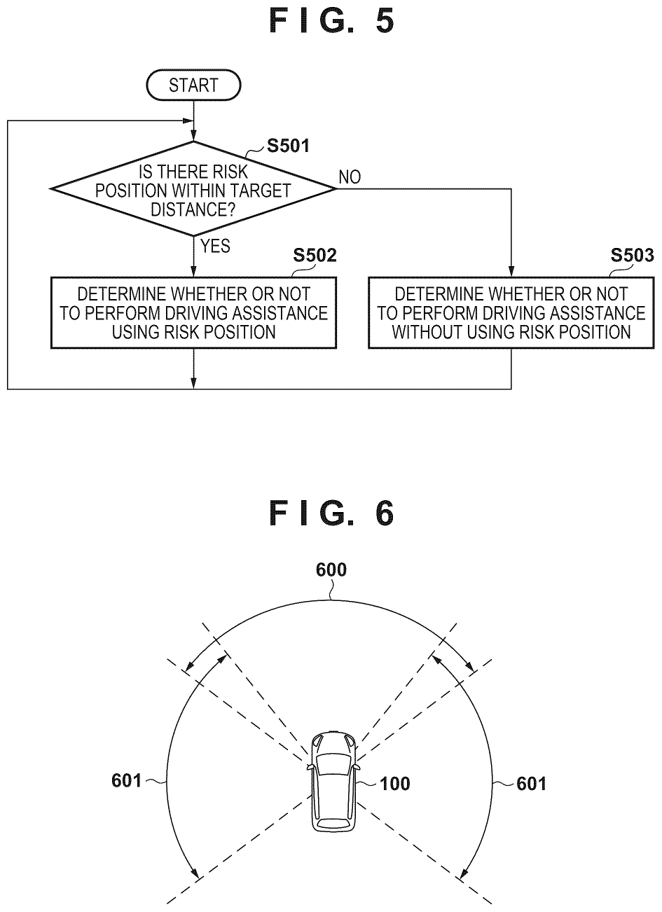

Driving assistance processing of some embodiments will be described with reference to FIG. 5. The driving assistance processing illustrated in a flowchart of FIG. 5 may be performed by the processing unit 110 performing a driving assistance program read from the storage unit 111 in the control device 108. The processing in FIG. 5 may be started, for example, in response to the setting of the driving assistance being turned on. The processing in FIG. 5 may be repeatedly performed until the setting of the driving assistance is turned off or the ignition of the vehicle 100 is turned off.

In step S501, the processing unit 110 (for example, the assistance unit 110c thereof) refers to the risk position information 112 stored in the storage unit 111 to determine whether or not a risk position exists within a predetermined distance (for example, 100 m) in the traveling direction of the self-vehicle 100. For example, the processing unit 110 can determine whether or not the risk position exists within the predetermined distance by comparing the current position of the vehicle 100 acquired by the acquisition unit 110a via the GNSS antenna 103 (GNSS module 113) with the coordinates (latitude and longitude) of each risk position included in the risk position information 112.

The processing unit 110 shifts the processing to step S502 in a case where the risk position exists within the predetermined distance (for example, 100 m) in the traveling direction of the self-vehicle 100, and shifts the processing to step S503 in a case where the risk position does not exist within the predetermined distance. In step S502, the processing unit 110 determines whether or not to perform driving assistance using the risk position included within the predetermined distance. Details of this processing will be described later. In step S503, the processing unit 110 determines whether or not to perform the driving assistance without using the risk position. Details of this processing will be described later.

With reference to FIG. 6, a range for selecting a driving assistance method when the risk position is not included within the predetermined distance in the traveling direction of the self-vehicle 100 will be described. A range 600 is located ahead of the vehicle 100. The ahead of the vehicle 100 may be a range including the front of the vehicle 100. As illustrated in FIG. 6, the range 600 may be a fan-shaped range or may have another shape. The fan-shaped range may be defined by a predetermined distance and a predetermined angle. The predetermined distance may be, for example, 800 m or more and 1000 m or less, for example, 900 m. The same applies to the predetermined distance in the following fan-shaped range. The range 600 may be symmetrical with respect to a direction of the front of the vehicle 100. A central angle of the range 600 may be, for example, about 100 to 110 degrees.

A range 601 is located on the side of the vehicle 100. The side of the vehicle 100 may be a range including the oblique front of the vehicle 100. The range 601 may include a direction just beside the vehicle 100. As illustrated in FIG. 6, the range 601 may be a fan-shaped range or may have another shape. The fan-shaped range may be defined by a predetermined distance and a predetermined angle. In the example of FIG. 6, the range 601 is located on each of the right side and the left side of the vehicle 100. A central angle of the range 601 may be, for example, about 80 to 90 degrees.

In the example of FIG. 6, a part of the range 600 and a part of the range 601 overlap. The central angle of the overlapped part may be, for example, about 10 to 20 degrees. In a case where a peripheral vehicle exists in the overlapped part, the peripheral vehicle is subjected to both driving assistance under the situation of FIG. 3A and driving assistance under the situation of FIG. 3B. Instead of the example of FIG. 6, the range 600 and the range 601 may be only in contact with each other or may be separated from each other. The range 600, the range 601 on the right side of the vehicle 100, and the range 601 on the left side of the vehicle 100 may have the same size, or at least a part thereof may have different sizes.

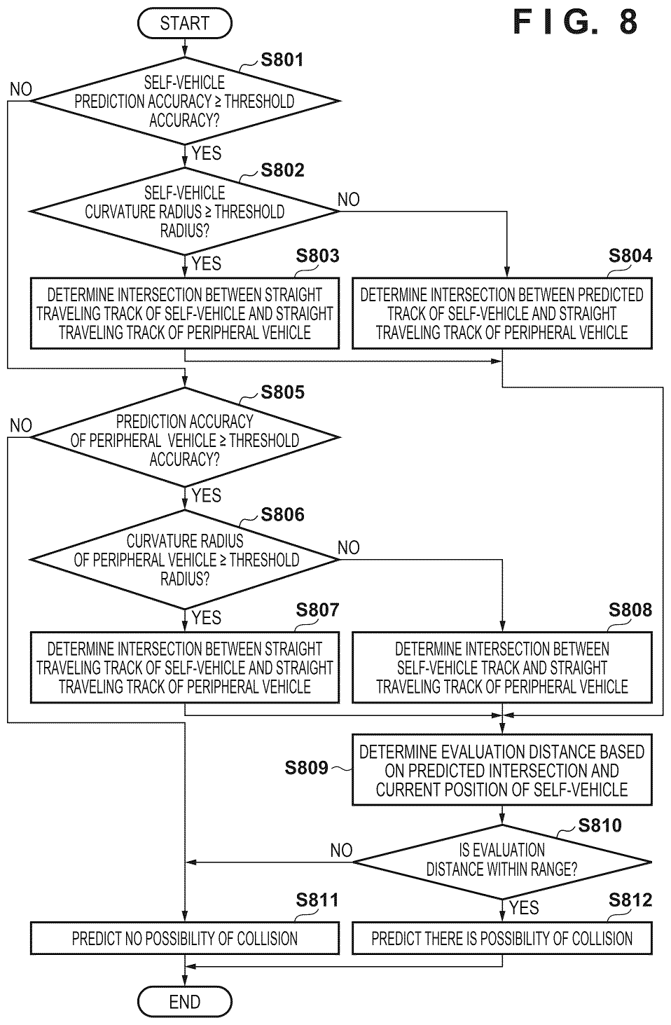

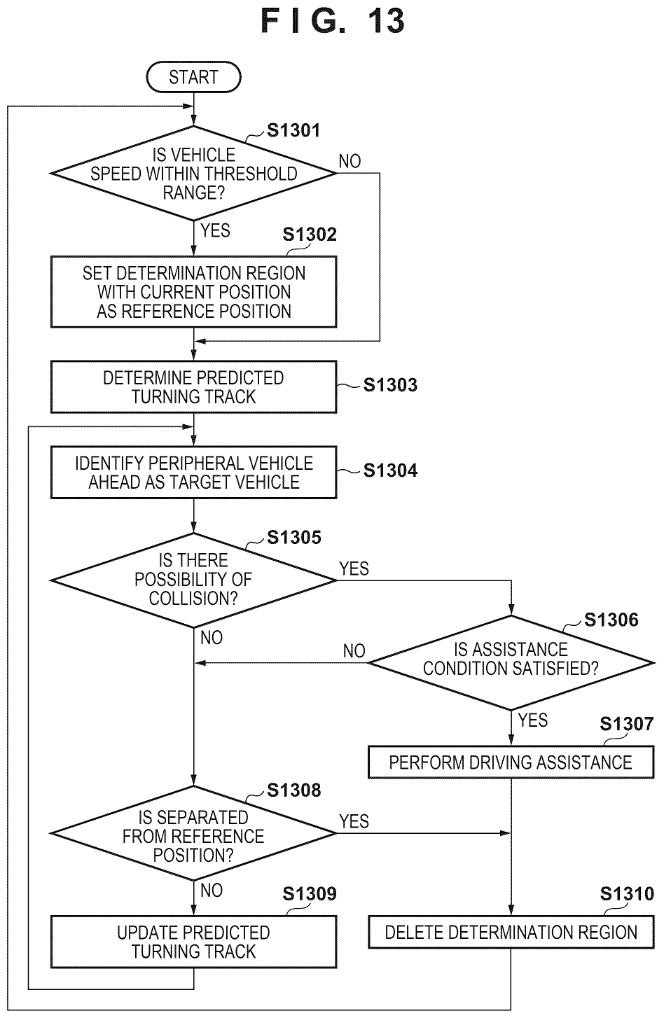

In a case where the peripheral vehicle is included in the range 601, as illustrated in FIG. 3A, the self-vehicle 100 may collide with another vehicle by traveling straight. Therefore, the control device 108 predicts the possibility of collision due to the self-vehicle 100 traveling straight. This operation will be described later with reference to FIGS. 7 to 12. Meanwhile, in a case where the peripheral vehicle is included in the range 600, as illustrated in FIG. 3B, the self-vehicle 100 may collide with another vehicle by turning left. Therefore, the control device 108 predicts the possibility of collision due to the self-vehicle 100 turning left. This operation will be described later with reference to FIGS. 13 to 16. The positions of the ranges 600 and 601 with respect to the self-vehicle 100 may be set in advance (for example, at the time of manufacturing the vehicle 100 or at the time of updating the software) and stored in the storage unit 111.

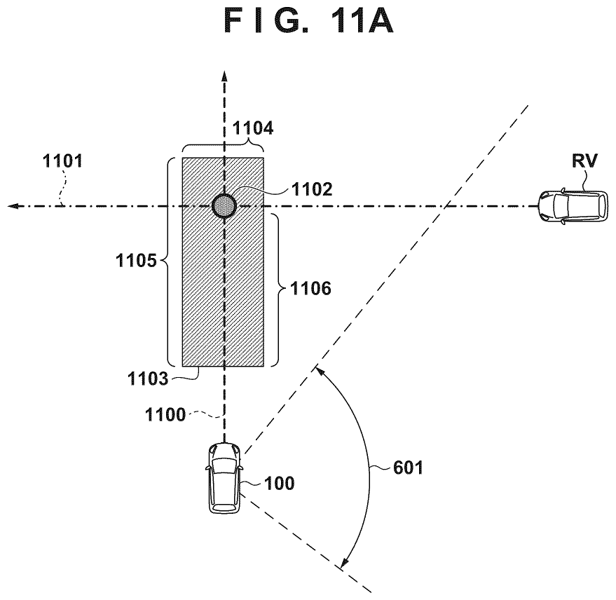

FIG. 7 illustrates an example of processing for performing driving assistance in a case where a peripheral vehicle RV (FIG. 10A) exists within the range 601 on the side of the self-vehicle 100 in step S503 (that is, processing when the risk position is not included within the predetermined distance in the traveling direction of the self-vehicle 100). The processing illustrated in the flowchart of FIG. 7 is performed by the processing unit 110 according to the driving assistance program read from the storage unit 111. Every time the peripheral vehicle RV is newly registered in step S702 of FIG. 7 while the driving assistance setting is turned on, for example, the processing in FIG. 7 may be performed for the peripheral vehicle RV. In the processing in FIG. 7, a plurality of other vehicles can be registered as peripheral vehicles. The processing in FIG. 7 is performed for each of the plurality of peripheral vehicles.

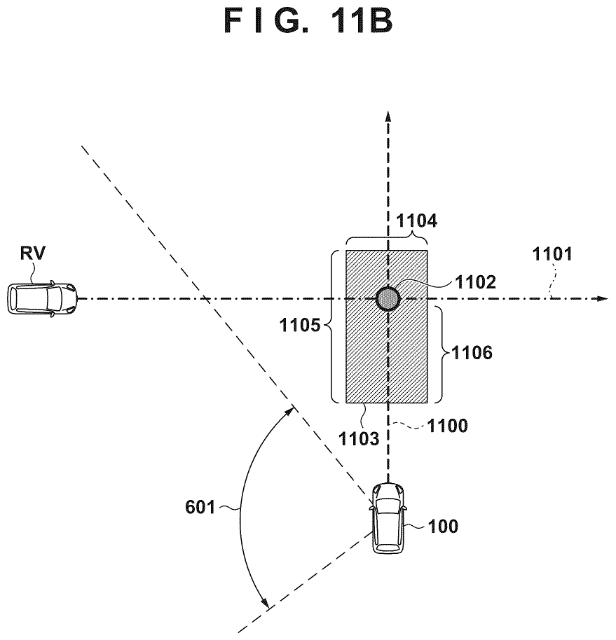

In step S701, the processing unit 110 (for example, the prediction unit 110b thereof) determines whether or not the peripheral vehicle RV exists within the range 601 on the side of the self-vehicle 100. In a case where it is determined that the peripheral vehicle RV exists within the range 601 on the side of the self-vehicle 100, the processing unit 110 shifts the processing to step S702, and repeats step S701 in other cases. This determination may be made based on the current position of the peripheral vehicle RV included in the latest peripheral vehicle information acquired from the peripheral vehicle RV. In an example illustrated in FIG. 11A, the peripheral vehicle RV exists within the range 601.

In step S702, the processing unit 110 (for example, the prediction unit 110b thereof) determines whether or not the predicted course of the self-vehicle 100 and the predicted course of the peripheral vehicle RV intersect. In a case where it is determined that these predicted courses of both the vehicles intersect, the processing unit 110 shifts the processing to step S703, and repeats step S702 in other cases. In a case where it is determined that the predicted course of the self-vehicle 100 and the predicted course of the peripheral vehicle RV intersect, the processing unit 110 specifies the coordinates of the predicted intersection.

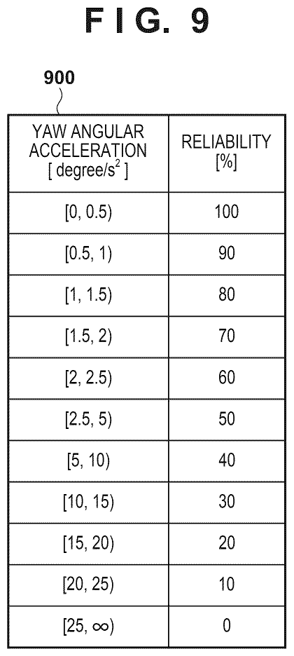

A specific example of the processing in step S702 will be described with reference to FIG. 8. In step S801, the processing unit 110 determines a predicted track of the self-vehicle 100 and prediction accuracy of the predicted track. Then, the processing unit 110 determines whether the prediction accuracy of the predicted track of the self-vehicle 100 is equal to or higher than threshold accuracy. In a case where it is determined that the prediction accuracy of the predicted track of the self-vehicle 100 is equal to or higher than the threshold accuracy, the processing unit 110 shifts the processing to step S802, and in a case where it is determined that the prediction accuracy of the predicted track of the self-vehicle 100 is lower than the threshold accuracy, the processing unit 110 shifts the processing to step S805.

The processing unit 110 may determine the predicted track of the self-vehicle 100 based on the self-vehicle information. For example, the processing unit 110 may calculate a current curvature radius based on the yaw rate included in the self-vehicle information, and determine an arc having this curvature radius as the predicted track.

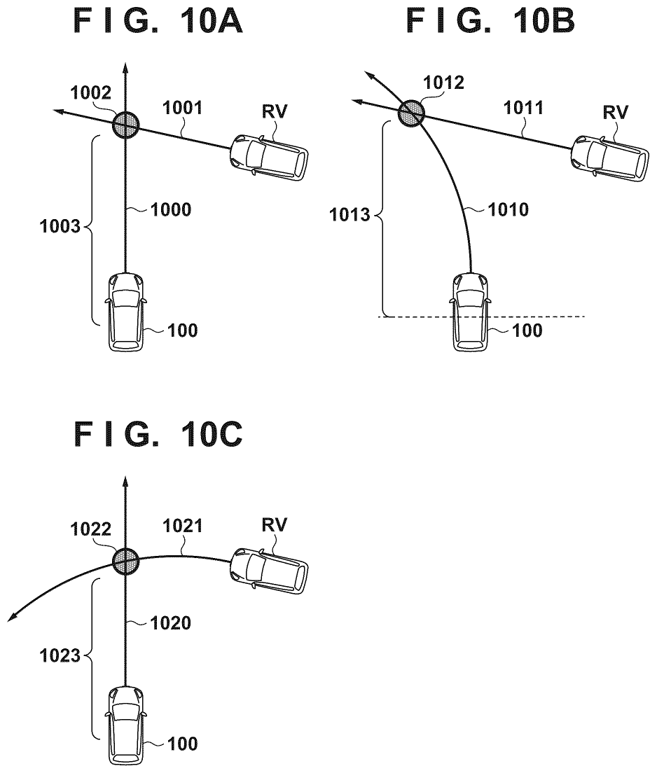

The processing unit 110 may determine the prediction accuracy of the predicted track of the self-vehicle 100 based on the current vehicle speed of the self-vehicle 100 and the current yaw rate of the self-vehicle 100. For example, the processing unit 110 may determine that the prediction accuracy of the predicted track is higher as the yaw angular acceleration of the self-vehicle 100 is smaller. The processing unit 110 may calculate the yaw angular acceleration by time-differentiating the yaw rate. For example, the processing unit 110 may determine the reliability of prediction of the predicted track by referring to a correspondence table 900 illustrated in FIG. 9. The correspondence table 900 shows a correspondence relation between the yaw angular acceleration and the reliability. The correspondence table 900 may be set in advance (for example, at the time of manufacturing the vehicle 100 or at the time of updating the software) and stored in the storage unit 111. In the correspondence table 900, the reliability of prediction of the predicted track is classified into 11 stages, and the prediction accuracy of the predicted track is higher as the reliability is higher. For example, in a case where the yaw angular acceleration is 1.5°/s² or more and less than 2°/s², the processing unit 110 determines that the reliability of prediction of the predicted track is 70%.

In general, measurement accuracy of the curvature radius of the self-vehicle 100 is low at a low vehicle speed. Therefore, the processing unit 110 may determine that the prediction accuracy of the predicted track is higher as the vehicle speed of the self-vehicle 100 is higher. For example, the processing unit 110 may classify the reliability of prediction of the predicted track into two stages. The processing unit 110 may determine that the reliability is high when the vehicle speed of the self-vehicle 100 is equal to or higher than a threshold vehicle speed (for example, 20 km/h), and may determine that the reliability is low when the vehicle speed of the self-vehicle 100 is lower than the threshold vehicle speed.

The processing unit 110 may combine the determination based on the yaw angular acceleration and the determination based on the vehicle speed. For example, the processing unit 110 may determine that the prediction accuracy of the predicted track of the self-vehicle 100 is equal to or higher than the threshold accuracy when the reliability determined based on the yaw angular acceleration is equal to or higher than the threshold reliability (for example, 70%) and the vehicle speed is equal to or higher than the threshold vehicle speed (for example, 20 km/h), and may determine that the prediction accuracy of the predicted track of the self-vehicle 100 is lower than the threshold accuracy in other cases.

In step S802, the processing unit 110 determines a current curvature radius of the self-vehicle 100. Then, the processing unit 110 determines whether the curvature radius of the self-vehicle 100 is equal to or larger than a threshold radius (for example, 3000 m). In a case where it is determined that the curvature radius of the self-vehicle 100 is equal to or larger than the threshold radius, the processing unit 110 shifts the processing to step S803, and in a case where it is determined that the curvature radius of the self-vehicle 100 is less than the threshold radius, the processing unit 110 shifts the processing to step S804.

In step S803, the processing unit 110 determines an intersection of a straight traveling track of the self-vehicle 100 and a straight traveling track of the peripheral vehicle RV as a predicted intersection. The straight traveling track is a track in a case where the self-vehicle 100 is assumed to travel straight. The processing of step S803 is executed in a case where it is determined that the curvature radius of the self-vehicle 100 is equal to or larger than the threshold radius (for example, 3000 m). In this case, it is considered that the occupant of the self-vehicle 100 intends to go straight on the self-vehicle 100. Therefore, the processing unit 110 determines a predicted intersection using the straight traveling track of the self-vehicle 100. An example of the predicted intersection in step S803 will be described with reference to FIG. 10A. In this example, an intersection of a straight traveling track 1000 of the self-vehicle 100 and a straight traveling track 1001 of the peripheral vehicle RV is determined as a predicted intersection 1002.

In step S804, the processing unit 110 determines an intersection of the predicted track of the self-vehicle 100 and the straight traveling track of the peripheral vehicle RV as a predicted intersection. The processing unit 110 may use the predicted track determined in step S801. The processing of step S804 is executed in a case where it is determined that the curvature radius of the self-vehicle 100 is less than the threshold radius (for example, 3000 m). In this case, it is considered that the occupant of the self-vehicle 100 intends to turn the self- vehicle 100. Therefore, the processing unit 110 determines the predicted intersection using the predicted track of the self-vehicle 100. An example of the predicted intersection in step S804 will be described with reference to FIG. 10B. In this example, an intersection of a predicted track 1010 of the self-vehicle 100 and a straight traveling track 1011 of the peripheral vehicle RV is determined as a predicted intersection 1012. The predicted track 1010 may be an arc having a determined curvature radius.

In step S805, the processing unit 110 determines the predicted track of the peripheral vehicle RV and the prediction accuracy of the predicted track. Then, the processing unit 110 determines whether the prediction accuracy of the predicted track of the peripheral vehicle RV is equal to or higher than the threshold accuracy. In a case where it is determined that the prediction accuracy of the predicted track of the peripheral vehicle RV is equal to or higher than the threshold accuracy, the processing unit 110 shifts the processing to step S806, and in a case where it is determined that the prediction accuracy of the predicted track of the peripheral vehicle RV is less than the threshold accuracy, the processing unit 110 shifts the processing to step S809.

The processing unit 110 may determine the predicted track of the peripheral vehicle RV based on the peripheral vehicle information. For example, the processing unit 110 may calculate the current curvature radius based on the yaw rate included in the peripheral vehicle information, and determine an arc having this curvature radius as the predicted track.

The processing unit 110 may determine the prediction accuracy of the predicted track of the peripheral vehicle RV based on the current vehicle speed of the peripheral vehicle RV and the current yaw rate of the peripheral vehicle RV. Since a method of determining the prediction accuracy of the predicted track of the peripheral vehicle RV may be similar to the above-described method of determining the prediction accuracy of the predicted track of the self-vehicle 100, redundant description will be omitted.

In step S806, the processing unit 110 determines the current curvature radius of the peripheral vehicle RV. Then, the processing unit 110 determines whether the curvature radius of the peripheral vehicle RV is equal to or larger than the threshold radius. In a case where it is determined that the curvature radius of the peripheral vehicle RV is equal to or larger than the threshold radius (for example, 3000 m), the processing unit 110 shifts the processing to step S807, and in a case where it is determined that the curvature radius of the peripheral vehicle RV is less than the threshold radius, the processing unit 110 shifts the processing to step S808.

In step S807, the processing unit 110 determines an intersection of the straight traveling track of the self-vehicle 100 and the straight traveling track of the peripheral vehicle RV as a predicted intersection. Since a method of determining the predicted intersection in step S807 may be similar to the method of determining the predicted intersection in step S803, redundant description will be omitted.

In step S808, the processing unit 110 determines an intersection of the straight traveling track of the self-vehicle 100 and the predicted track of the peripheral vehicle RV as a predicted intersection. The processing unit 110 may use the predicted track determined in step S805. The processing of step S808 is executed in a case where it is determined that the curvature radius of the peripheral vehicle RV is less than the threshold radius (for example, 3000 m). In this case, it is considered that the occupant of the peripheral vehicle RV intends to turn the peripheral vehicle RV. Therefore, the processing unit 110 determines the predicted intersection using the predicted track of the peripheral vehicle RV. An example of the predicted intersection in step S808 will be described with reference to FIG. 10C. In this example, an intersection of a straight traveling track 1020 of the self-vehicle 100 and a predicted track 1021 of the peripheral vehicle RV is determined as a predicted intersection 1022. The predicted track 1021 may be an arc having a determined curvature radius.

After determining the predicted intersection in step S803, step S804, step S807, or step S808, the processing unit 110 determines the evaluation distance based on the predicted intersection and the current position of the self-vehicle 100 in step S809. The evaluation distance may be a distance for evaluating an approach situation between the self-vehicle 100 and the peripheral vehicle RV. As described above, according to the method of FIG. 8, the processing unit 110 determines the evaluation distance for evaluating the approach situation between the self-vehicle 100 and the peripheral vehicle RV based on the predicted track of the self-vehicle 100 and the predicted track of the peripheral vehicle RV. In addition, the processing unit 110 selects a method of determining the evaluation distance from a plurality of determination method candidates based on the prediction accuracy of the predicted track of the self-vehicle 100, the curvature radius of the predicted track of the self-vehicle 100, the prediction accuracy of the predicted track of the peripheral vehicle RV, and the curvature radius of the predicted track of the peripheral vehicle RV.

The evaluation distance will be described with reference to FIGS. 10A to 10C again. As illustrated in FIG. 10A, when the predicted intersection 1002 is on the straight traveling track 1000 of the self-vehicle 100, the processing unit 110 may determine a distance 1003 between the self-vehicle 100 and the predicted intersection 1002 as the evaluation distance. In FIG. 10C, similarly, the processing unit 110 may determine a distance 1023 between the self-vehicle 100 and the predicted intersection 1022 as the evaluation distance.

As illustrated in FIG. 10B, when the predicted intersection 1012 is not on the straight traveling track of the self-vehicle 100, the processing unit 110 may determine the distance 1013 between the self-vehicle 100 and the predicted intersection 1012 as the evaluation distance. Alternatively, the processing unit 110 may determine, as the evaluation distance, a straight-line distance between a plane passing through a part (for example, a center) of the self-vehicle 100 and having the traveling direction as a normal and the predicted intersection 1012. Alternatively, the processing unit 110 may determine a distance on the predicted track 1010 between the self-vehicle 100 and the predicted intersection 1012 as the evaluation distance.

In step S810, the processing unit 110 determines whether or not the evaluation distance determined in step S809 is included in a predetermined range (for example, 100 m). The processing unit 110 shifts the processing to step S811 in a case where it is determined that the evaluation distance is included in the predetermined range (for example, 100 m), and shifts the processing to step S812 in a case where it is determined that the evaluation distance is not included in the predetermined range.

In step S811, the processing unit 110 determines that there is no possibility of collision. In a case where step S811 is executed, the processing unit 110 shifts the processing to step S707 of FIG. 7 after the processing of FIG. 8 ends. In step S812, the processing unit 110 determines that there is a possibility of collision. In a case where step S812 is executed, the processing unit 110 shifts the processing to step S703 of FIG. 7 after the processing of FIG. 8 ends. The determination result that there is a possibility of collision may be changed in subsequent processing (for example, step S704 in FIG. 7).

In a case where it is determined that the prediction accuracy of the predicted track of the self-vehicle 100 is less than the threshold accuracy and the prediction accuracy of the predicted track of the peripheral vehicle RV is less than the threshold accuracy, the processing unit 110 may predict that there is no possibility of collision between the self-vehicle 100 and the peripheral vehicle RV, in step S811. In a case where the prediction accuracy of the predicted track of each of the self-vehicle 100 and the peripheral vehicle RV is low, there is a possibility that driving assistance (for example, notification to the occupant) is performed even though the situation is not a situation where both the vehicles approach. Therefore, in such a case, by predicting that there is no possibility of collision and suppressing driving assistance (for example, notification to the occupant), it is possible to prevent the occupant from feeling annoyed.

In the method of FIGS. 10A to 10C described above, the processing unit 110 determines the predicted intersection using the straight traveling track of the peripheral vehicle RV in steps S803 and S804. Alternatively, when it is determined in steps S803 and S804 that the prediction accuracy of the predicted track of the peripheral vehicle RV is equal to or higher than the threshold accuracy and the curvature radius of the peripheral vehicle RV is less than the threshold radius, the processing unit 110 may determine the predicted intersection using the predicted track of the peripheral vehicle RV.

Returning to the description of FIG. 7, in step S703, the processing unit 110 (for example, the prediction unit 110b thereof) sets a determination region with the predicted intersection determined by the method of FIG. 8 as a reference position, and stores the determination region in the storage unit 111. The determination region may be a region where a possibility of collision is predicted. An example of a determination region 1103 set using a predicted intersection 1102 as a reference position will be described with reference to FIG. 11A. In the example illustrated in FIG. 11A, similarly to FIG. 10A, an intersection of a straight traveling track 1100 of the self-vehicle 100 and a straight traveling track 1101 of the peripheral vehicle RV is determined as the predicted intersection 1102. Alternatively, the description of FIG. 11A is also applicable to the case of FIG. 10B or FIG. 10C.

The determination region 1103 may be a rectangle including the predicted intersection 1102 and a side parallel to the straight traveling track 1100 of the self-vehicle 100. Alternatively, the determination region 1103 may have another shape. The position of the determination region 1103 with respect to the predicted intersection 1102 and the shape thereof may be set in advance (for example, at the time of manufacturing the vehicle 100 or at the time of updating the software,) and stored in the storage unit 111. In a case where a risk position exists near the determination region 1103, the processing unit 110 may expand the determination region 1103 to include the risk position.

The processing unit 110 may set the determination region 1103 having a different shape (size) in each of a case where the peripheral vehicle RV is on the right side (that is, a side opposite to the opposite lane side) with respect to the self-vehicle 100 as illustrated in FIG. 11A, and a case where the peripheral vehicle RV is on the left side (that is, the opposite lane side) with respect to the self-vehicle 100 as illustrated in FIG. 11B. A length 1104 of the determination region 1103 in a vehicle width direction may be the same length (for example, 3 m to 4 m, which is a length corresponding to one lane) regardless of whether the peripheral vehicle RV is on the right side or the left side of the self-vehicle 100. A length 1105 of the determination region 1103 in a vehicle length direction in a case where the peripheral vehicle RV is on the right side of the self-vehicle 100 may be larger than a length 1105 of the determination region 1103 in the vehicle length direction in a case where the peripheral vehicle RV is on the left side of the self-vehicle 100. The length 1105 of the determination region 1103 in the vehicle length direction in a case where the peripheral vehicle RV is on the right side of the self-vehicle 100 may be 9 m to 11 m, which is a length corresponding to three lanes, for example. The length 1105 of the determination region 1103 in the vehicle length direction in a case where the peripheral vehicle RV is on the left side of the self-vehicle 100 may be 6 m to 8 m, which is a length corresponding to two lanes, for example.

The distance between a side of the determination region 1103 far from the self-vehicle 100 and the predicted intersection 1102 may be the same (for example, about 1.5 m equivalent to a half lane) regardless of whether the peripheral vehicle RV is on the right side or the left side of the self-vehicle 100. As a result, a length 1106 of a part located closer to the self-vehicle 100 than the predicted intersection 1102 in the determination region 1103 in a case where the peripheral vehicle RV is on the right side of the self-vehicle 100 is larger than a length 1106 of a part located closer to the self-vehicle 100 than the predicted intersection 1102 in the determination region 1103 in a case where the peripheral vehicle RV is on the left side of the self-vehicle 100. In a case where the peripheral vehicle RV is on the right side of the self-vehicle 100, there is a possibility that there is an opposite lane of the lane on which the peripheral vehicle RV is traveling between the predicted intersection 1102 and the self-vehicle 100. Therefore, by expanding the determination region 1103 toward the self-vehicle 100, it is possible to suppress a collision with another vehicle (which may not have a vehicle-to-vehicle communication function) traveling on this opposite lane.

In step S704, the processing unit 110 (for example, the prediction unit 110b thereof) predicts the possibility of collision between the self-vehicle 100 and the peripheral vehicle RV in the determination region 1103. In a case where it is determined that there is a possibility of collision between the self-vehicle 100 and the peripheral vehicle RV, the processing unit 110 shifts the processing to step S705, and shifts the processing to step S707 in other cases.

The possibility of collision may be determined based on a predicted time (hereinafter, simply referred to as the “arrival time”) until the peripheral vehicle RV arrives at the predicted intersection 1102. This arrival time may be calculated based on, for example, the latest peripheral vehicle information acquired from the peripheral vehicle RV. For example, the processing unit 110 can predict the predicted time of the peripheral vehicle RV to the predicted intersection 1102 by dividing the distance between the peripheral vehicle RV and the predicted intersection 1102 by the speed of the peripheral vehicle RV.

The processing unit 110 may predict that there is a possibility of collision in a case where the arrival time is equal to or less than a threshold time, and may determine that there is no possibility of collision in a case where the arrival time is more than the threshold time. The threshold time may be settable by the occupant of the self-vehicle 100.

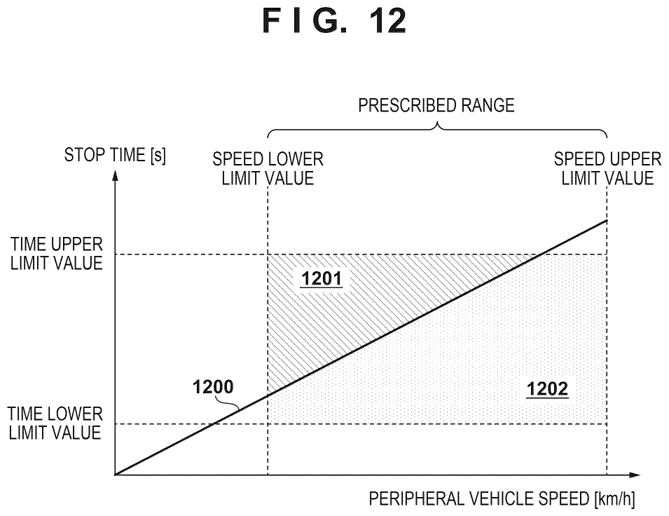

The processing unit 110 may change the threshold time according to the speed of the peripheral vehicle RV. FIG. 12 is a diagram illustrating a relation between the speed of the peripheral vehicle RV and the stop time of the peripheral vehicle RV. The stop time of the peripheral vehicle RV is a time until the peripheral vehicle RV stops at deceleration (for example, 0.4 G) by a typical braking operation. FIG. 12 illustrates a prescribed range (speed upper limit value and speed lower limit value) related to the speed of the peripheral vehicle RV and a time upper limit value and a time lower limit value related to time to collision (TTC). The prescribed range is a speed range of the peripheral vehicle RV on which driving assistance for the self-vehicle 100 is performed. The time upper limit value is an upper limit value of the time to collision arbitrarily set by the driver or the like, and the time lower limit value is a lower limit value of the time to collision set from the measurement location accuracy of the GNSS.

The processing unit 110 sets the stop time corresponding to the speed of the peripheral vehicle RV as the threshold time based on the “relation between the speed of the peripheral vehicle RV and the stop time” indicated by a line 1200 in FIG. 12. The line 1200 shows a boundary between a typical braking operation (that is, an operation for decelerating the vehicle in normal times) and an emergency braking operation (that is, an operation for suddenly stopping the vehicle). For example, the line 1200 may have a slope corresponding to 0.4 G because the typical braking operation deceleration is 0.4 G or less. In a region 1201 above the line 1200, the arrival time is longer than the stop time, and if a driver of the peripheral vehicle RV performs the typical braking operation, the peripheral vehicle RV can be stopped before the peripheral vehicle RV arrives at a predicted intersection 1102. Therefore, when the arrival time is longer than the threshold time (stop time), driving assistance for the self-vehicle SV can be suppressed. On the other hand, in a region 1202 below the line 1200, the arrival time is shorter than the stop time, and even if the driver of the peripheral vehicle RV performs the typical braking operation (for example, deceleration of 0.4 G), the peripheral vehicle RV can arrive at the predicted intersection 1102 before the peripheral vehicle RV is stopped. Therefore, when the arrival time is equal to or less than the threshold time (stop time), driving assistance for the self-vehicle SV can be performed. Note that the processing unit 110 may change the threshold time continuously or stepwise according to the speed of the peripheral vehicle RV.

The possibility of collision may be determined based on entry of the self-vehicle 100 into the determination region 1103 instead of or in addition to the arrival time until the peripheral vehicle RV arrives at the predicted intersection 1102. For example, the processing unit 110 may predict that there is a possibility of collision in a case where the self-vehicle 100 has entered the determination region 1103, and may determine that there is no possibility of collision in a case where the self-vehicle 100 has not entered the determination region 1103.

Furthermore, the possibility of collision may be determined based on a difference (hereinafter, referred to as the “arrival time difference”) between the predicted time until the peripheral vehicle RV arrives at the predicted intersection 1102 and the predicted time until the self-vehicle 100 arrives at the predicted intersection 1102. The processing unit 110 may predict that there is a possibility of collision in a case where the arrival time difference is equal to or less than the threshold time, and may determine that there is no possibility of collision in a case where the arrival time difference is larger than the threshold time. The threshold time may be settable by the occupant of the self-vehicle 100.

The possibility of collision may be determined by arbitrarily combining the above three conditions (that is, the arrival time is equal to or less than the threshold time, the self-vehicle 100 has entered the determination region 1103, and the arrival time difference is equal to or less than another threshold time). For example, in a case where all of these three conditions are satisfied, the processing unit 110 may determine that there is a possibility of collision, and may determine that there is no possibility of collision in other cases. Alternatively, in a case where at least one of these three conditions is satisfied, the processing unit 110 may determine that there is a possibility of collision, and may determine that there is no possibility of collision in other cases. Alternatively, in a case where at least one of the two preset conditions of these three conditions is satisfied, the processing unit 110 may determine that there is a possibility of collision, and determine that there is no possibility of collision in other cases. Specifically, in a case where the predicted time until the peripheral vehicle RV arrives at the predicted intersection 1102 is smaller than a first threshold time, the processing unit 110 may predict that there is a possibility of collision if the arrival time difference is smaller than a second threshold time, and may predict that there is no possibility of collision if the arrival time difference is larger than the second threshold time.

In step S705, the processing unit 110 (for example, the assistance unit 110c thereof) determines whether or not the assistance condition is satisfied. In a case where it is determined that the assistance condition is satisfied, the processing unit 110 shifts the processing to step S706, and shifts the processing to step S707 in other cases. The assistance condition may be a condition to be satisfied in order to perform driving assistance. For example, the assistance condition may be based on whether or not the speed of the peripheral vehicle RV is within a prescribed range. The prescribed range can be set in advance using the speed lower limit value and the speed upper limit value related to the speed of the peripheral vehicle RV. In a case where the speed of the peripheral vehicle RV is equal to or less than the speed lower limit value in the prescribed range, there is a high possibility that the driver of the peripheral vehicle RV notices the self-vehicle 100 and decelerates the peripheral vehicle RV without colliding with the self-vehicle 100. That is, the speed lower limit value in the prescribed range related to the speed of the peripheral vehicle RV can be set to a value that allows the peripheral vehicle RV to be decelerated without colliding with the self-vehicle 100. In addition, in a case where the speed of the peripheral vehicle RV is equal to or larger than the upper limit value of the prescribed range, there is a high possibility that the peripheral vehicle RV is not a vehicle traveling on a road into which the self-vehicle 100 enters, such as traveling on an expressway in the vicinity of the road into which the self-vehicle 100 enters. That is, the upper limit value of the prescribed range related to the speed of the peripheral vehicle RV can be set to a value that enables determination of whether the vehicle is traveling on a road into which the self-vehicle 100 enters or traveling on an expressway in the vicinity of the road. In this manner, the driving assistance is performed/suppressed according to whether or not the speed of the peripheral vehicle RV is within the prescribed range, so that it is possible to reduce a feeling of annoyance of a driver of the self-vehicle 100 towards the driving assistance.

In step S706, the processing unit 110 (for example, the assistance unit 110c thereof) performs driving assistance for the self-vehicle 100. As driving assistance for the self-vehicle 100, the processing unit 110 can notify the occupant of the self-vehicle 100 of the possibility of collision by the notification device 105, and perform a braking operation of the self-vehicle 100 by the braking device 106.

In step S708, the processing unit 110 (for example, the prediction unit 110b thereof) deletes, from the storage unit 111, the determination region (the determination region stored in step S703) that becomes unnecessary due to performance of the driving assistance. As a result, the capacity of the storage unit 111 is suppressed from being consumed by unnecessary information.

In a case where it is determined in step S704 that there is no possibility of collision or in a case where it is determined in step S705 that the assistance condition is not satisfied, step S707 is performed. In step S707, the processing unit 110 (for example, the prediction unit 110b thereof) determines whether or not the registration of the peripheral vehicle RV to be processed in the method of FIG. 7 has been canceled in step S405 of FIG. 4. In a case where it is determined that the registration of the peripheral vehicle RV has been canceled, the processing unit 110 shifts the processing to step S708, and shifts the processing to step S702 in other cases. In a case where the registration of the peripheral vehicle RV has been canceled, it is considered that the peripheral vehicle RV no longer exists around the self-vehicle 100. Therefore, the processing unit 110 ends the processing without performing driving assistance for the collision with the peripheral vehicle RV. Also in this case, in step S708, the processing unit 110 (for example, the prediction unit 110b thereof) deletes the unnecessary determination region from the storage unit 111.

In a case where it is determined in step S707 that the registration of the peripheral vehicle RV has not been canceled, the processing returns to step S702. In this case, in a case where the predicted course of the self-vehicle 100 still intersects with the predicted course of the peripheral vehicle RV, the determination region is set using the predicted intersection 1102 as a reference position in step S703. In a case where a vehicle (the self-vehicle 100 or the peripheral vehicle RV) changes its position in the lane or changes the lane, the position of the predicted intersection 1102 can change. Since the peripheral vehicle information is repeatedly acquired, the processing unit 110 can detect such a change in the position of the predicted intersection 1102. Therefore, in step S703, the processing unit 110 (for example, the prediction unit 110b thereof) resets a reference position based on the newly acquired peripheral vehicle information, and updates the determination region stored in the storage unit 111 accordingly. As a result, the determination in step S704 is performed based on the updated determination region. In a case where the predicted intersection 1102 cannot be determined in step S703, the most recently determined reference position and determination region may be maintained.

As described above, the processing unit 110 repeatedly determines the predicted intersection at predetermined time intervals. The processing unit 110 may increase the threshold time used for comparison with the above-described arrival time in a case where the change amount of the position of the predicted intersection is equal to or larger than the predetermined threshold change amount. When the change amount of the position of the predicted intersection is large, it is considered that the predicted track of the self-vehicle 100 or the peripheral vehicle RV is changed. Therefore, by increasing the threshold time, it is easy to predict that there is a possibility of collision, so that safety is improved.

According to the method of FIG. 7, in a case where a plurality of peripheral vehicles exist within the range 601 on the side of the self-vehicle 100, an individual reference position for each of the plurality of peripheral vehicles is used. Specifically, the method of FIG. 7 is performed individually for each of the plurality of peripheral vehicles. As a result, the predicted intersection of the predicted course of the self-vehicle 100 and the predicted course of the peripheral vehicle is also determined for each of the plurality of peripheral vehicles. As a result, for each of the plurality of peripheral vehicles, an individual determination region is set based on the individual reference position. Therefore, the possibility of collision with each of the plurality of peripheral vehicles can be appropriately predicted.

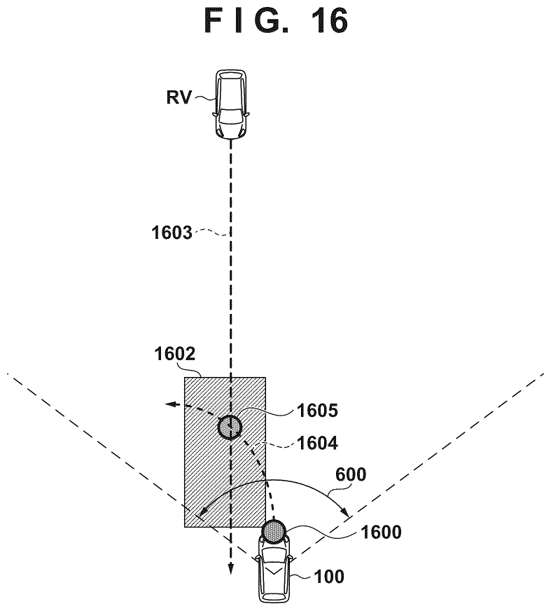

FIG. 13 illustrates an example of processing for performing driving assistance when the peripheral vehicle RV (FIG. 16) exists within the range 600 in front of the self-vehicle 100 in step S503 (that is, processing when the risk position is not included within the predetermined distance in the traveling direction of the self-vehicle 100). The processing illustrated in the flowchart of FIG. 13 is performed by the processing unit 110 according to the learning program read from the storage unit 111. The processing in FIG. 13 may be started, for example, in response to the setting of the driving assistance being turned on. The processing of FIG. 13 may be repeatedly performed until the setting of the driving assistance is turned off or the ignition of the vehicle 100 is turned off.

In step S1301, the processing unit 110 (for example, the prediction unit 110b thereof) determines whether or not the vehicle speed of the self-vehicle 100 is within a threshold range. The processing unit 110 shifts the processing to step S1302 in a case where it is determined that the vehicle speed of the self-vehicle 100 is within the threshold range, and shifts the processing to step S1303 in other cases. This determination may be made based on the vehicle speed and the acceleration of the self-vehicle 100 included in the latest self-vehicle information. An upper end of the threshold used in step S1301 is a value below the vehicle speed after the vehicle 100 decelerates to turn (for example, left turn or right turn), and may be, for example, 20 km/h. A lower end of the threshold used in step S1301 is a value below the vehicle speed in a state where the vehicle 100 is stopped or substantially stopped, and may be, for example, 2 km/h. The position where the self-vehicle 100 is determined to be within the threshold range is referred to as a turning preparation position 1601 (FIG. 16). Note that the self-vehicle 100 can be within the threshold range even in a case of not turning. Even in this case, the processing unit 110 detects the turning preparation position 1601 and performs the processing of and after step S1302.

In step S1302, the processing unit 110 (for example, the prediction unit 110b thereof) sets a determination region using the turning preparation position 1601 as a reference position, and stores the reference position and the determination region in the storage unit 111. The determination region may be a region where a possibility of collision is predicted. An example of a determination region 1602 set using the turning preparation position 1601 as a reference position will be described with reference to FIG. 16. The determination region 1602 may be a rectangle centered at a position on the left front of the turning preparation position 1601 and including a side parallel to the vehicle length direction of the self-vehicle 100. The length of the determination region 1602 in the vehicle width direction of the self-vehicle 100 may be, for example, 3 m to 4 m, which is a length corresponding to one lane. The length of the determination region 1602 in the vehicle length direction of the self-vehicle 100 may be, for example, 9 m to 11 m, which is a length corresponding to three lanes. The lower right corner of the determination region 1602 may overlap the turning preparation position 1601. Alternatively, the determination region 1602 may have another shape. The position of the determination region 1602 with respect to the reference position may be set in advance (for example, at the time of manufacturing the vehicle 100 or at the time of updating the software) and stored in the storage unit 111. In a case where a risk position exists near the determination region 1602, the processing unit 110 may expand the determination region 1602 to include the risk position. The processing unit 110 sets the determination region 1602 to include the turning preparation position 1601 (that is, the reference position) and to be offset to the opposite lane side (the left side in the example of FIG. 16) with respect to the self-vehicle 100 in the direction orthogonal to the predicted course of the self-vehicle 100. This makes it possible to appropriately predict the possibility of the collision that may occur when the self-vehicle 100 turns left.

Processing of and after step S1303 is executed using the reference position and the determination region set in step S1302. As described above, since the method of FIG. 13 is repeatedly executed, steps S1301 and S1302 are also repeatedly executed. Therefore, the reference position and the determination region are continuously updated while the vehicle speed of the self-vehicle 100 is within the threshold range (for example, 2 km/h or more and less than 20 km/h), and the processing of and after step S1303 is executed using the latest reference position and determination region. The update of the reference position and the determination region is stopped in response to the vehicle speed of the self-vehicle 100 being outside the threshold range (for example, less than 2 km/h or 20 km/h or more), and the processing of and after step S1303 is executed using the reference position and the determination region when the update is stopped. When the reference position and the determination region are not set at the time of execution of step S1303, the processing unit 110 may omit steps S1303 to S1310 and return the processing to step S1301.

In step S1303, the processing unit 110 (for example, the prediction unit 110b thereof) determines a predicted turning track 1604 of the self-vehicle 100. The predicted turning track 1604 may be a turning track predicted when the self-vehicle 100 turns (for example, left turn) to the opposite lane side. The predicted turning track 1604 may be set in advance (for example, at the time of manufacturing the vehicle 100 or at the time of updating the software) and stored in the storage unit 111. The predicted turning track 1604 set in advance as described above may be referred to as a default predicted turning track 1604.

A plurality of candidates of the predicted turning track 1604 may be stored in the storage unit 111. The processing unit 110 (for example, the prediction unit 110b thereof) may select one predicted turning track 1604 from the plurality of candidates of the predicted turning track 1604 based on the steering angle of the self-vehicle 100 at the turning preparation position 1601 and use the selected predicted turning track 1604 for subsequent processing. For example, in a case where the steering angle of the self-vehicle 100 is small, it is considered that the self-vehicle 100 is about to turn left at a small intersection, so that the processing unit 110 may select the predicted turning track 1604 having a small curvature radius. On the other hand, in a case where the steering angle of the self-vehicle 100 is large, it is considered that the self-vehicle 100 is about to turn left at a large intersection, so that the processing unit 110 may select the predicted turning track 1604 having a large curvature radius.

In step S1304, the processing unit 110 (for example, the prediction unit 110b thereof) identifies the peripheral vehicle RV existing within the range 600 ahead of the self-vehicle 100 as a target vehicle of the subsequent processing. If no peripheral vehicle RV exists within the range 600, no target vehicle is identified. If a plurality of peripheral vehicles RV exist within the range 600, all of the plurality of peripheral vehicles RV are identified as target vehicles. This identification may be made based on the current position of the peripheral vehicle RV included in the latest peripheral vehicle information acquired from the peripheral vehicle RV. In the example illustrated in FIG. 16, one peripheral vehicle RV exists within the range 600.

In step S1305, the processing unit 110 (for example, the prediction unit 110b thereof) predicts the possibility of collision between the self-vehicle 100 and the peripheral vehicle RV in the determination region 1602. In a case where it is determined that there is a possibility of collision between the self-vehicle 100 and the peripheral vehicle RV, the processing unit 110 shifts the processing to step S1306, and shifts the processing to step S1308 in other cases.

The possibility of collision may be determined based on the fact that an intersection 1605 between the predicted turning track 1604 determined in step S1303 and a predicted course 1603 of the peripheral vehicle RV is included in the determination region 1602. For example, the processing unit 110 may determine that there is a possibility of collision in a case where the intersection 1605 is included in the determination region 1602, and may determine that there is no possibility of collision in a case where the intersection 1605 is not included in the determination region 1602.

Further, the possibility of collision may be determined based on the evaluation distance determined based on the predicted track of the self-vehicle 100 and the predicted track of the peripheral vehicle RV. As described above, the evaluation distance is a distance for evaluating an approach situation between the self-vehicle 100 and the peripheral vehicle RV.

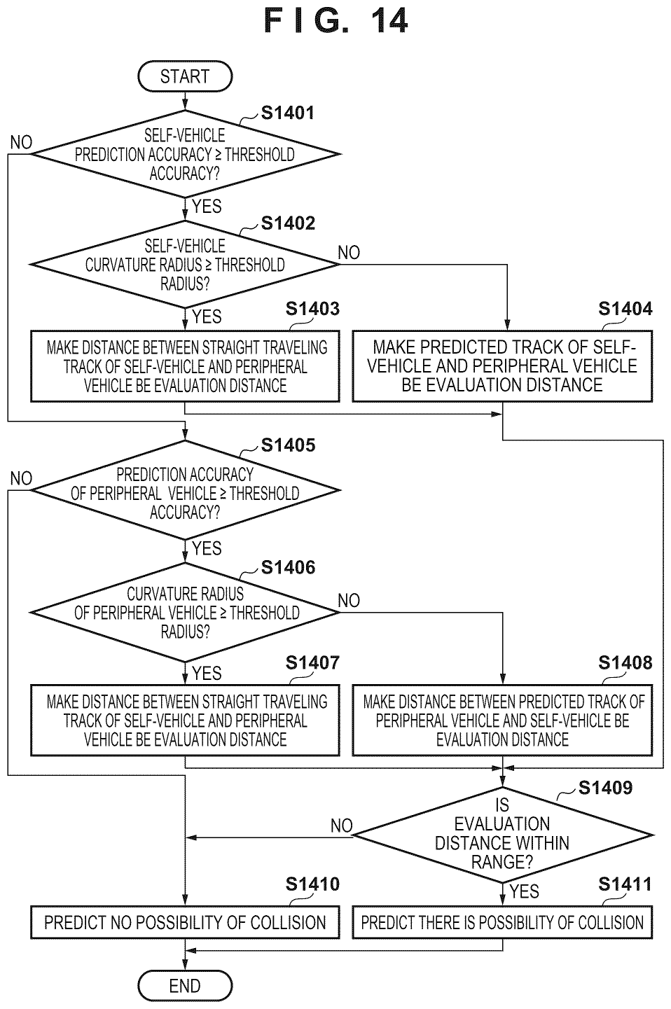

A specific example of a method of determining the possibility of collision based on the evaluation distance will be described with reference to FIG. 14. Since steps S1401 and S1402 may be similar to steps S801 and S802 in FIG. 8, redundant description will be omitted.

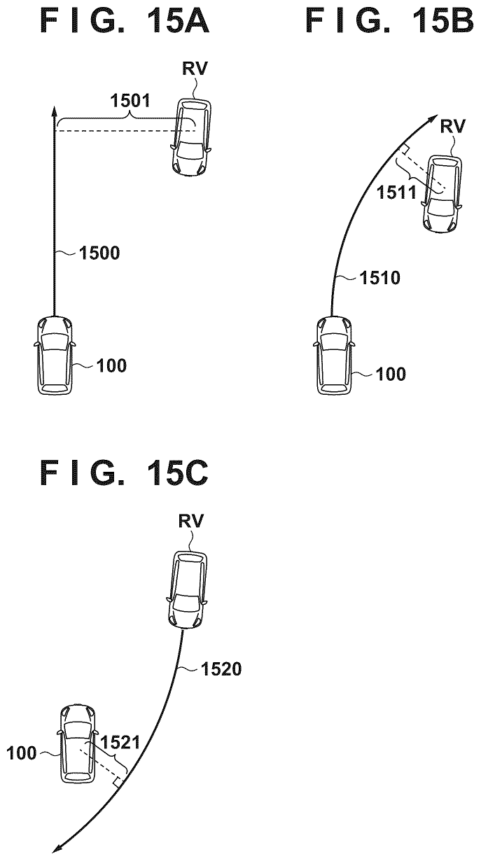

In step S1403, the processing unit 110 determines the distance between the straight traveling track of the self-vehicle 100 and the peripheral vehicle RV as the evaluation distance. The straight traveling track is a track in a case where the self-vehicle 100 is assumed to travel straight. The processing of step S1403 is executed in a case where it is determined that the curvature radius of the self-vehicle 100 is equal to or larger than the threshold radius (for example, 3000 m). In this case, it is considered that the occupant of the self-vehicle 100 intends to go straight on the self-vehicle 100. Therefore, the processing unit 110 determines the evaluation distance using the straight traveling track of the self-vehicle 100. An example of the evaluation distance in step S1403 will be described with reference to FIG. 15A. In this example, a distance 1501 between the straight traveling track 1500 of the self-vehicle 100 and the peripheral vehicle RV is determined as the evaluation distance. In the description of FIGS. 15A to 15C, the distance between the track and the vehicle may be the shortest distance between the track and the center of the vehicle. Alternatively, other parts of the vehicle may be used for determining the distance.

In step S1404, the processing unit 110 determines the distance between the predicted track of the self-vehicle 100 and the peripheral vehicle RV as the evaluation distance. The processing unit 110 may use the predicted track determined in step S1401. The processing of step S1404 is executed when it is determined that the curvature radius of the self-vehicle 100 is less than the threshold radius (for example, 3000 m). In this case, it is considered that the occupant of the self-vehicle 100 intends to turn the self-vehicle 100. Therefore, the processing unit 110 determines the evaluation distance using the predicted track of the self-vehicle 100. An example of the evaluation distance in step S1404 will be described with reference to FIG. 15B. In this example, a distance 1511 between a predicted track 1510 of the self-vehicle 100 and the peripheral vehicle RV is determined as the evaluation distance. The predicted track 1510 may be an arc having a determined curvature radius.

Since steps S1405 and S1406 may be similar to steps S805 and S806 in FIG. 8, redundant description will be omitted. In step S1407, the processing unit 110 determines the distance between the straight traveling track of the self-vehicle 100 and the peripheral vehicle RV as the evaluation distance. Since a method of determining the evaluation distance in step S1407 may be similar to the method of determining the evaluation distance in step S1403, redundant description will be omitted.

In step S1408, the processing unit 110 determines the distance between the predicted track of the peripheral vehicle RV and the self-vehicle 100 as the evaluation distance. The processing unit 110 may use the predicted track determined in step S1405. The processing of step S1408 is executed when it is determined that the curvature radius of the peripheral vehicle RV is less than the threshold radius (for example, 3000 m). In this case, it is considered that the occupant of the peripheral vehicle RV intends to turn the peripheral vehicle RV. Therefore, the processing unit 110 determines the evaluation distance using the predicted track of the peripheral vehicle RV. An example of the evaluation distance in step S1408 will be described with reference to FIG. 15C. In this example, a distance 1521 between a predicted track 1520 of the peripheral vehicle RV and the self-vehicle 100 is determined as the evaluation distance. The predicted track 1520 may be an arc having a determined curvature radius.

In step S1409, the processing unit 110 determines whether or not the evaluation distance determined in step S1403, S1404, S1407, or S1408 is included in a predetermined range (for example, 3 m to 4 m, which is a length corresponding to one lane.). The processing unit 110 shifts the processing to step S1410 in a case where it is determined that the evaluation distance is not included in the predetermined range, and shifts the processing to step S1411 in a case where it is determined that the evaluation distance is included in the predetermined range.

In step S1410, the processing unit 110 determines that there is no possibility of collision. In step S1411, the processing unit 110 determines that there is a possibility of collision. This determination result is used in step S1306.

In a case where it is determined that the prediction accuracy of the predicted track of the self-vehicle 100 is less than the threshold accuracy and the prediction accuracy of the predicted track of the peripheral vehicle RV is less than the threshold accuracy, in step S1410, the processing unit 110 may predict that there is no possibility of collision between the self-vehicle 100 and the peripheral vehicle RV. In a case where the prediction accuracy of the predicted track of each of the self-vehicle 100 and the peripheral vehicle RV is low, there is a possibility that driving assistance (for example, notification to the occupant) is performed even though the situation is not a situation where both the vehicles approach. Therefore, in such a case, by predicting that there is no possibility of collision and suppressing driving assistance (for example, notification to the occupant), it is possible to prevent the occupant from feeling annoyed.

As described above, according to the method of FIG. 14, the processing unit 110 determines the evaluation distance for evaluating the approach situation between the self-vehicle 100 and the peripheral vehicle RV based on the predicted track of the self-vehicle 100 and the predicted track of the peripheral vehicle RV. In addition, the processing unit 110 selects a method of determining the evaluation distance from a plurality of determination method candidates based on the prediction accuracy of the predicted track of the self-vehicle 100, the curvature radius of the predicted track of the self-vehicle 100, the prediction accuracy of the predicted track of the peripheral vehicle RV, and the curvature radius of the predicted track of the peripheral vehicle RV.

Returning to the description of FIG. 13, in step S1306, the processing unit 110 (for example, the assistance unit 110c thereof) determines whether or not the assistance condition is satisfied. In a case where it is determined that the assistance condition is satisfied, the processing unit 110 shifts the processing to step S1307, and shifts the processing to step S1308 in other cases. Since step S1306 may be similar to step S705, redundant description will be omitted.

In step S1307, the processing unit 110 (for example, the assistance unit 110c thereof) performs driving assistance for the self-vehicle 100. As driving assistance for the self-vehicle 100, the processing unit 110 can notify an occupant of the self-vehicle 100 of the possibility of collision by the notification device 105, and perform a braking operation of the self-vehicle 100 by the braking device 150.

In step S1310, the processing unit 110 (for example, the prediction unit 110b thereof) deletes, from the storage unit 111, the reference position and the determination region (the reference position and the determination region stored in step S703) that becomes unnecessary due to performance of the driving assistance. As a result, the capacity of the storage unit 111 is suppressed from being consumed by unnecessary information.

In a case where it is determined in step S1305 that there is no possibility of collision or in a case where it is determined in step S1306 that the assistance condition is not satisfied, step S1309 is performed. In step S1308, the processing unit 110 (for example, the prediction unit 110b thereof) determines whether or not the self-vehicle 100 is separated from the reference position stored in step S1302 by a predetermined distance (for example, 30 m) or more. In a case where it is determined that the self-vehicle 100 is separated from the reference position by the predetermined distance or more, the processing unit 110 shifts the processing to step S1310, and shifts the processing to step S1309 in other cases. In a case where the self-vehicle 100 is separated from the reference position by the predetermined distance or more, it is considered that there is no possibility that the self-vehicle 100 collides with the peripheral vehicle RV at that point. Therefore, the processing unit 110 ends the processing without performing driving assistance for the collision with the peripheral vehicle RV. Also in this case, in step S1310, the processing unit 110 (for example, the prediction unit 110b thereof) deletes the unnecessary reference position and determination region from the storage unit 111.

In a case where it is determined in step S1308 that the self-vehicle 100 is not separated from the reference position by the predetermined distance or more, step S1309 is performed. In step S1309, the processing unit 110 (for example, the prediction unit 110b thereof) may update the predicted turning track 1604 based on the change in the steering angle of the self-vehicle 100. For example, in a case where the self-vehicle 100 turns left at a steering angle larger than that assumed by the predicted turning track 1604, the processing unit 110 may update the predicted turning track 1604 such that the curvature radius decreases. On the other hand, in a case where the self-vehicle 100 turns left at a steering angle smaller than that assumed by the predicted turning track 1604, the processing unit 110 may update the predicted turning track 1604 such that the curvature radius increases. The predicted turning track 1604 may be updated when the current steering angle of the self-vehicle 100 is equal to or larger than the steering angle of the default predicted turning track 1604. Thereafter, the processing unit 110 shifts the processing to step S1304 to identify a peripheral vehicle RV newly included within the range 600 as a target vehicle of the subsequent processing. Further, the possibility of collision in step S1305 is determined based on the updated predicted turning track 1604.

According to the method of FIG. 13, in a case where a plurality of peripheral vehicles exist within the range 600 ahead of the self-vehicle 100, the reference position common to the plurality of peripheral vehicles (that is, the turning preparation position 1601) is used. As a result, for each of the plurality of peripheral vehicles, a common determination region is set based on the common reference position. This makes it possible to appropriately estimate the possibility of collision when the self-vehicle 100 turns to the opposite lane side (for example, when turning left).

According to the above-described embodiment, the possibility of collision can be appropriately predicted according to the position of the peripheral vehicle. As a result, driving assistance for the self-vehicle 100 can be appropriately performed. Note that, even in a state where driving assistance based on peripheral vehicle information acquired from a peripheral vehicle through vehicle-to-vehicle communication is not performed, driving assistance based on other criteria (for example, based on a detection result of a camera or a radar) may be performed.

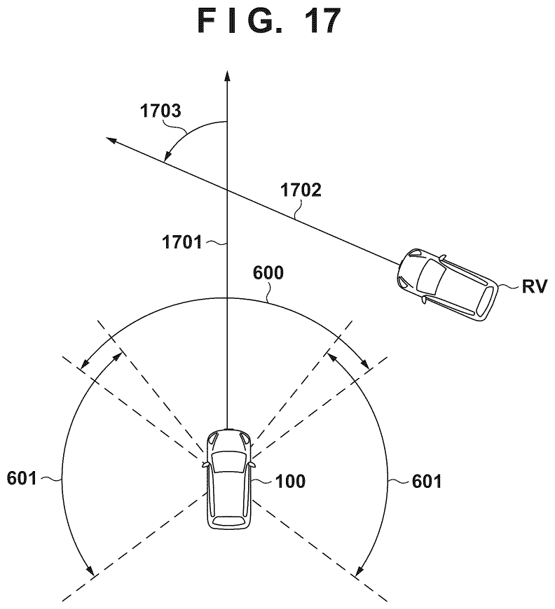

In the driving assistance method described above, based on the peripheral vehicle RV being located within the range 600 or 601 of FIG. 6, the peripheral vehicle RV is set as a prediction target of the possibility of collision. Based on other information, the processing unit 110 may determine whether or not the peripheral vehicle RV is set as a prediction target of the possibility of collision. An example of a method of determining the peripheral vehicle RV to be set as a prediction target of the possibility of collision will be described with reference to FIG. 17.

Further, based on a rotation angle 1703 of a course vector 1702 of the peripheral vehicle RV with respect to a course vector 1701 of the self-vehicle 100, the processing unit 110 may determine whether or not the peripheral vehicle RV is set as a prediction target of the possibility of collision. The course vector 1701 may also be a unit vector facing a traveling direction of a vehicle. For the sake of explanation, the rotation angle 1703 is set such that a clockwise direction is positive and a counterclockwise direction is negative. The processing unit 110 can determine the approach direction of the peripheral vehicle RV based on the direction of the peripheral vehicle RV with respect to the self-vehicle 100 and the rotation angle 1703 of the course vector 1702 of the peripheral vehicle RV with respect to the course vector 1701 of the self-vehicle 100.

Even if the peripheral vehicle RV is included in the range 600 ahead of the self-vehicle 100, it is considered that there is no possibility of collision between the self-vehicle 100 and the peripheral vehicle RV in a case where the peripheral vehicle RV is traveling in the same direction as the self-vehicle 100 or traveling in the rightward direction or the leftward direction with respect to the self-vehicle 100. Therefore, in a case where the peripheral vehicle RV is within the range 600 ahead of the self-vehicle 100 and the rotation angle 1703 is within a predetermined range (for example, 160° to 200°), the processing unit 110 may set the peripheral vehicle RV as a determination target of the possibility of collision in the processing of FIGS. 7 and 13.

Even if the peripheral vehicle RV is included in the range 601 on the right side of the self-vehicle 100, it is considered that there is no possibility of collision between the self-vehicle 100 and the peripheral vehicle RV in a case where the peripheral vehicle RV is traveling in the same direction as or opposite direction to the self-vehicle 100 or traveling in the rightward direction with respect to the self-vehicle 100. Therefore, in a case where the peripheral vehicle RV is within the range 601 on the right side of the self-vehicle 100 and the rotation angle 1703 is within a predetermined range (for example, −110° to −70°), the processing unit 110 may set the peripheral vehicle RV as a determination target of the possibility of collision in the processing of FIGS. 7 and 13.

Even if the peripheral vehicle RV is included in the range 601 on the left side of the self-vehicle 100, it is considered that there is no possibility of collision between the self-vehicle 100 and the peripheral vehicle RV in a case where the peripheral vehicle RV is traveling in the same direction as or opposite direction to the self-vehicle 100 or traveling in the leftward direction with respect to the self-vehicle 100. Therefore, in a case where the peripheral vehicle RV is within the range 601 on the left side of the self-vehicle 100 and the rotation angle 1703 is within a predetermined range (for example, 70° to 110°), the processing unit 110 may set the peripheral vehicle RV as a determination target of the possibility of collision in the processing of FIGS. 7 and 13.

Next, in step S502 of FIG. 5, processing for determining whether or not to perform driving assistance using a risk position included within a predetermined distance will be described. The processing unit 110 may predict the possibility of collision between the self-vehicle 100 and the peripheral vehicle RV based on the traveling track of another vehicle associated with the risk position in the risk position information 112 and the peripheral vehicle information. The traveling track of another vehicle included in the risk position information 112 may be a traveling track which the self-vehicle 100 has intersected in the past. For example, in the processing of FIG. 8, the processing unit 110 may use a traveling track of another vehicle included in the risk position information 112 instead of the predicted track of the peripheral vehicle RV.

Next, a specific example of a notification method by the processing unit 110 (for example, the assistance unit 110c thereof) will be described. When it is predicted that the self-vehicle 100 and the peripheral vehicle RV may collide with each other and the self-vehicle 100 performs the starting operation, the processing unit 110 may notify the occupant using a predetermined notification sound through the speaker 105c. The processing unit 110 may display approach information including calling attention to the occupant on the MID 105a. When it is predicted that the self-vehicle 100 and the peripheral vehicle RV may collide with each other, the processing unit 110 may display the approach direction of the peripheral vehicle RV on the HUD 105b.

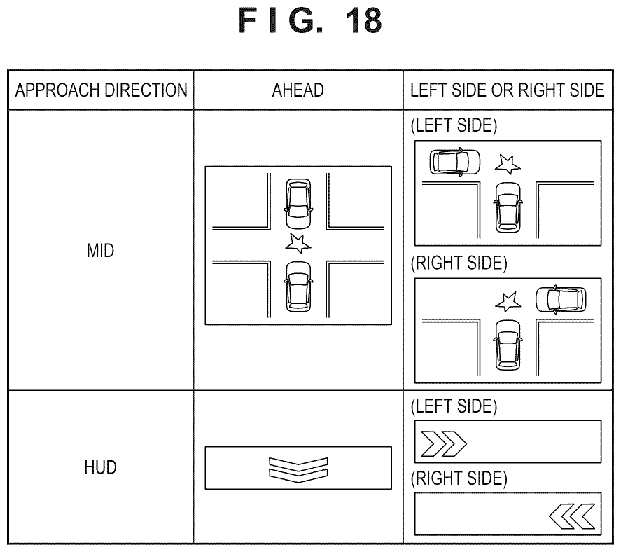

A specific example of display by the MID 105a and the HUD 105b will be described with reference to FIG. 18. The processing unit 110 may display an icon illustrated in FIG. 18 when it is predicted that the self-vehicle 100 and the peripheral vehicle RV may collide with each other. Specifically, when the approach direction of the peripheral vehicle RV with respect to the self-vehicle 100 is within the range 600 ahead of the self-vehicle 100 and the self-vehicle 100 turns (for example, left turn) to the left side, the processing unit 110 may display, on the MID 105a, that another vehicle is approaching from the front of the self-vehicle 100, and display calling attention to the front of the self-vehicle 100 on the HUD 105b.

When the approach direction of the peripheral vehicle RV with respect to the self-vehicle 100 is within the range 601 on the right side of the self-vehicle 100, the processing unit 110 may display, on the MID 105a, that another vehicle is approaching from the right side of the self-vehicle 100, and display calling attention to the right side of the self-vehicle 100 on the HUD 105b. When the approach direction of the peripheral vehicle RV with respect to the self-vehicle 100 is within the range 601 on the left side of the self-vehicle 100, the processing unit 110 may display, on the MID 105a, that another vehicle is approaching from the left side of the self-vehicle 100, and display calling attention to the left side of the self-vehicle 100 on the HUD 105b.

### SUMMARY OF EMBODIMENTS

### Item 1

A driving assistance device (108) including:
a storage unit (111) configured to store risk position information (112) indicating a risk position where there is a possibility that a self-vehicle (100) mounted with the driving assistance device will collide with another vehicle;
an acquisition unit (110a) configured to acquire peripheral vehicle information indicating a vehicle speed, a position, a traveling track, and a yaw rate of a peripheral vehicle (RV) existing around the self-vehicle from the peripheral vehicle by vehicle-to-vehicle communication;
a prediction unit (110b) configured to predict a possibility of collision between the self-vehicle and the peripheral vehicle based on self-vehicle information indicating a vehicle speed, a position, a traveling track, and a yaw rate of the self-vehicle and the peripheral vehicle information; and
a notification unit (110c) configured to notify an occupant of the self-vehicle based on a prediction result by the prediction unit, wherein
in a case where the risk position is not included within a predetermined distance in a traveling direction of the self-vehicle,
   the prediction unit determines a predicted track (1010, 1510) of the self-vehicle based on the self-vehicle information, and determines a predicted track (1021, 1520) of the peripheral vehicle based on the peripheral vehicle information,
   the prediction unit determines an evaluation distance (1003, 1013, 1023, 1501, 1511, 1521) for evaluating an approach situation between the self-vehicle and the peripheral vehicle based on the predicted track of the self-vehicle and the predicted track of the peripheral vehicle, and
   the prediction unit predicts that there is no possibility of collision between the self-vehicle and the peripheral vehicle when the evaluation distance is not included in a predetermined range.

According to this item, driving assistance of the self-vehicle can be appropriately performed. Specifically, it is possible to suppress excessive notification to the occupant.

### Item 2

The driving assistance device according to item 1, wherein
the prediction unit determines prediction accuracy of the predicted track of the self-vehicle based on the vehicle speed of the self-vehicle and the yaw rate of the self-vehicle,
the prediction unit determines prediction accuracy of the predicted track of the peripheral vehicle based on the vehicle speed of the peripheral vehicle and the yaw rate of the peripheral vehicle, and
the prediction unit selects a method of determining the evaluation distance from a plurality of determination method candidates based on the prediction accuracy of the predicted track of the self-vehicle, a curvature radius of the predicted track of the self-vehicle, the prediction accuracy of the predicted track of the peripheral vehicle, and a curvature radius of the predicted track of the peripheral vehicle.

According to this item, driving assistance of the self-vehicle can be more appropriately performed.

### Item 3

The driving assistance device according to item 2, wherein
in a case where the peripheral vehicle exists within a first range (601) ahead of the self-vehicle and the prediction accuracy of the predicted track of the self-vehicle is equal to or higher than threshold accuracy,
   when the curvature radius of the predicted track of the self-vehicle is equal to or larger than a threshold radius, the prediction unit determines a distance (1501) between a straight traveling track (1500) of the self-vehicle and the peripheral vehicle as the evaluation distance, and
   when the curvature radius of the predicted track of the self-vehicle is less than the threshold radius, the prediction unit determines a distance (1511) between the predicted track (1510) of the self-vehicle and the peripheral vehicle as the evaluation distance.

According to this item, driving assistance of the self-vehicle can be more appropriately performed.

### Item 4

The driving assistance device according to item 3, wherein
in a case where the peripheral vehicle exists within the first range ahead of the self-vehicle, the prediction accuracy of the predicted track of the self-vehicle is less than the threshold accuracy, and the prediction accuracy of the predicted track of the peripheral vehicle is equal to or higher than the threshold accuracy,
   when the curvature radius of the predicted track of the peripheral vehicle is equal to or larger than the threshold radius, the prediction unit determines a distance (1501) between a straight traveling track (1500) of the self-vehicle and the peripheral vehicle as the evaluation distance, and
   when the curvature radius of the predicted track of the peripheral vehicle is less than the threshold radius, the prediction unit determines a distance (1521) between the predicted track (1520) of the peripheral vehicle and the self-vehicle as the evaluation distance.

According to this item, driving assistance of the self-vehicle can be more appropriately performed.

### Item 5

The driving assistance device according to item 4, wherein
the prediction unit predicts that there is no possibility of collision between the self-vehicle and the peripheral vehicle when the peripheral vehicle exists within the first range ahead of the self-vehicle, the prediction accuracy of the predicted track of the self-vehicle is less than the threshold accuracy, and the prediction accuracy of the predicted track of the peripheral vehicle is less than the threshold accuracy.

According to this item, driving assistance of the self-vehicle can be more appropriately performed.

### Item 6

The driving assistance device according to any one of items 1 to 5, wherein
in a case where the peripheral vehicle exists within a second range (600) on a side of the self-vehicle,
   when prediction accuracy of the predicted track of the self-vehicle is equal to or higher than threshold accuracy and a curvature radius of the predicted track of the self-vehicle is equal to or larger than a threshold radius, the prediction unit determines an intersection (1002) of a straight traveling track (1000) of the self-vehicle and a straight traveling track (1001) of the peripheral vehicle as a predicted intersection,
   when the prediction accuracy of the predicted track of the self-vehicle is equal to or higher than the threshold accuracy and the curvature radius of the predicted track of the self-vehicle is less than the threshold radius, the prediction unit determines an intersection (1012) of the predicted track (1010) of the self-vehicle and the straight traveling track (1011) of the peripheral vehicle as the predicted intersection,
   when the prediction accuracy of the predicted track of the self-vehicle is less than the threshold accuracy, prediction accuracy of the predicted track of the peripheral vehicle is equal to or higher than the threshold accuracy, and a curvature radius of the predicted track of the peripheral vehicle is equal to or larger than the threshold radius, the prediction unit determines the intersection (1002) of the straight traveling track (1000) of the self-vehicle and the straight traveling track (1001) of the peripheral vehicle as the predicted intersection,
   when the prediction accuracy of the predicted track of the self-vehicle is less than the threshold accuracy, the prediction accuracy of the predicted track of the peripheral vehicle is equal to or higher than the threshold accuracy, and the curvature radius of the predicted track of the peripheral vehicle is less than the threshold radius, the prediction unit determines an intersection (1022) of the straight traveling track (1020) of the self-vehicle and the predicted track (1021) of the peripheral vehicle as the predicted intersection, and
the prediction unit determines the evaluation distance based on the predicted intersection and a current position of the self-vehicle.

According to this item, driving assistance of the self-vehicle can be more appropriately performed.

### Item 7

The driving assistance device according to item 6, wherein
the prediction unit predicts that there is no possibility of collision between the self-vehicle and the peripheral vehicle when the peripheral vehicle exists within the second range on the side of the self-vehicle, the prediction accuracy of the predicted track of the self-vehicle is less than the threshold accuracy, and the prediction accuracy of the predicted track of the peripheral vehicle is less than the threshold accuracy.

According to this item, driving assistance of the self-vehicle can be more appropriately performed.

### Item 8

The driving assistance device according to item 7, wherein
when the peripheral vehicle exists within the second range on the side of the self-vehicle,
   the prediction unit determines an arrival time until the peripheral vehicle arrives at the predicted intersection based on the peripheral vehicle information,
   the prediction unit predicts that there is a possibility of collision between the self-vehicle and the peripheral vehicle when the arrival time is equal to or less than a first threshold time, and
the first threshold time is determined based on the vehicle speed of the peripheral vehicle.

According to this item, driving assistance of the self-vehicle can be more appropriately performed.

### Item 9

The driving assistance device according to item 8, wherein
the prediction unit repeatedly determines the predicted intersection at predetermined time intervals, and
the prediction unit increases the first threshold time when a change amount of a position of the predicted intersection is equal to or larger than a predetermined threshold change amount.

According to this item, driving assistance of the self-vehicle can be more appropriately performed.

### Item 10

The driving assistance device according to any one of items 1 to 9, wherein
the prediction unit repeatedly determines whether or not the peripheral vehicle exists within a first range ahead of the self-vehicle at predetermined time intervals, and
the prediction unit repeatedly determines whether or not the peripheral vehicle exists within a second range on a side of the self-vehicle at predetermined time intervals.

According to this item, driving assistance of the self-vehicle can be more appropriately performed.

### Item 11

The driving assistance device according to any one of items 1 to 10, wherein
the risk position information further includes a traveling track of another vehicle associated with the risk position, and
when the risk position is included within the predetermined distance in a traveling direction of the self-vehicle, the prediction unit predicts a possibility of collision between the self-vehicle and the peripheral vehicle based on the traveling track of another vehicle associated with the risk position and the peripheral vehicle information.

According to this item, driving assistance of the self-vehicle can be more appropriately performed.

### Item 12

The driving assistance device according to any one of items 1 to 11, wherein
the notification unit notifies the occupant using a predetermined notification sound when it is predicted that there is a possibility that the self-vehicle and the peripheral vehicle will collide with each other and the self-vehicle performs a starting operation,
the self-vehicle includes a first display unit (105a) and a second display unit (105b) provided at a position different from a position of the first display unit, and
the notification unit displays approach information including calling attention to the occupant on the first display unit, and when it is predicted that there is a possibility that the self-vehicle and the peripheral vehicle will collide with each other, the notification unit displays an approach direction of the peripheral vehicle on the second display unit.

According to this item, the notification can be performed to enable occupant's easy recognition.

### Item 13

The driving assistance device according to item 12, wherein
the prediction unit determines the approach direction of the peripheral vehicle based on a direction of the peripheral vehicle with respect to the self-vehicle and a rotation angle of a course of the peripheral vehicle with respect to a course of the self-vehicle.

According to this item, the notification can be performed to enable occupant's easy recognition.

### Item 14

The driving assistance device according to item 13, wherein
a first side is one of a right side and a left side which is a side of a road on which passage is mandatory in a region where the self-vehicle is located, and a second side is a side opposite to the first side, and
in a case where it is predicted that there is a possibility that the self-vehicle and the peripheral vehicle will collide with each other,
   when the approach direction is within a first range ahead of the self-vehicle and the self-vehicle turns to the second side, the notification unit displays, on the first display unit, that another vehicle approaches from the front of the self-vehicle and displays, on the second display unit, calling attention to the front of the self-vehicle,
   when the approach direction is within a second range on the first side of the self-vehicle, the notification unit displays, on the first display unit, that another vehicle approaches from the first side of the self-vehicle, and displays, on the second display unit, calling attention to the first side of the self-vehicle, and
   when the approach direction is within a second range on the second side of the self-vehicle, the notification unit displays, on the first display unit, that another vehicle approaches from the second side of the self-vehicle, and displays, on the second display unit, calling attention to the second side of the self-vehicle.

According to this item, the notification can be performed to enable occupant's easy recognition.

### Item 15

A driving assistance method including:
storing risk position information (112) indicating a risk position where there is a possibility that a self-vehicle (100) will collide with another vehicle;
acquiring peripheral vehicle information indicating a vehicle speed, a position, a traveling track, and a yaw rate of a peripheral vehicle (RV) existing around the self-vehicle from the peripheral vehicle by vehicle-to-vehicle communication;
predicting a possibility of collision between the self-vehicle and the peripheral vehicle based on self-vehicle information indicating a vehicle speed, a position, a traveling track, and a yaw rate of the self-vehicle and the peripheral vehicle information; and
notifying an occupant of the self-vehicle based on a prediction result in the predicting, wherein
in a case where the risk position is not included within a predetermined distance in a traveling direction of the self-vehicle, the predicting includes
   determining a predicted track (1010, 1510) of the self-vehicle based on the self-vehicle information, and determines a predicted track (1021, 1520) of the peripheral vehicle based on the peripheral vehicle information,
   determining an evaluation distance (1003, 1013, 1023, 1501, 1511, 1521) for evaluating an approach situation between the self-vehicle and the peripheral vehicle based on the predicted track of the self-vehicle and the predicted track of the peripheral vehicle, and
   predicting that there is no possibility of collision between the self-vehicle and the peripheral vehicle when the evaluation distance is not included in a predetermined range.

According to this item, driving assistance of the self-vehicle can be appropriately performed. Specifically, it is possible to suppress excessive notification to the occupant.

### Item 16

A non-transitory computer readable storage medium storing a program for causing a computer to execute:
storing risk position information (112) indicating a risk position where there is a possibility that a self-vehicle (100) will collide with another vehicle;
acquiring peripheral vehicle information indicating a vehicle speed, a position, a traveling track, and a yaw rate of a peripheral vehicle (RV) existing around the self-vehicle from the peripheral vehicle by vehicle-to-vehicle communication;
predicting a possibility of collision between the self-vehicle and the peripheral vehicle based on self-vehicle information indicating a vehicle speed, a position, a traveling track, and a yaw rate of the self-vehicle and the peripheral vehicle information; and
notifying an occupant of the self-vehicle based on a prediction result in the predicting, wherein
in a case where the risk position is not included within a predetermined distance in a traveling direction of the self-vehicle, the predicting includes
   determining a predicted track (1010, 1510) of the self-vehicle based on the self-vehicle information, and determines a predicted track (1021, 1520) of the peripheral vehicle based on the peripheral vehicle information,
   determining an evaluation distance (1003, 1013, 1023, 1501, 1511, 1521) for evaluating an approach situation between the self-vehicle and the peripheral vehicle based on the predicted track of the self-vehicle and the predicted track of the peripheral vehicle, and
   predicting that there is no possibility of collision between the self-vehicle and the peripheral vehicle when the evaluation distance is not included in a predetermined range.

According to this item, driving assistance of the self-vehicle can be appropriately performed. Specifically, it is possible to suppress excessive notification to the occupant.

The invention is not limited to the foregoing embodiments, and various variations/changes are possible within the spirit of the invention.

What is claimed is:

1. A driving assistance device comprising:
a storage unit configured to store risk position information indicating a risk position where there is a possibility that a self-vehicle mounted with the driving assistance device will collide with another vehicle;
an acquisition unit configured to acquire peripheral vehicle information indicating a vehicle speed, a position, a traveling track, and a yaw rate of a peripheral vehicle existing around the self-vehicle from the peripheral vehicle by vehicle-to-vehicle communication;
a prediction unit configured to predict a possibility of collision between the self-vehicle and the peripheral vehicle based on self-vehicle information indicating a vehicle speed, a position, a traveling track, and a yaw rate of the self-vehicle and the peripheral vehicle information; and
a notification unit configured to notify an occupant of the self-vehicle based on a prediction result by the prediction unit, wherein
in a case where the risk position is not included within a predetermined distance in a traveling direction of the self-vehicle,
the prediction unit determines a predicted track of the self-vehicle based on the self-vehicle information, and determines a predicted track of the peripheral vehicle based on the peripheral vehicle information,
the prediction unit determines an evaluation distance for evaluating an approach situation between the self-vehicle and the peripheral vehicle based on the predicted track of the self-vehicle and the predicted track of the peripheral vehicle, and
the prediction unit predicts that there is no possibility of collision between the self-vehicle and the peripheral vehicle when the evaluation distance is not included in a predetermined range.

2. The driving assistance device according to claim 1, wherein
the prediction unit determines prediction accuracy of the predicted track of the self-vehicle based on the vehicle speed of the self-vehicle and the yaw rate of the self-vehicle,
the prediction unit determines prediction accuracy of the predicted track of the peripheral vehicle based on the vehicle speed of the peripheral vehicle and the yaw rate of the peripheral vehicle, and
the prediction unit selects a method of determining the evaluation distance from a plurality of determination method candidates based on the prediction accuracy of the predicted track of the self-vehicle, a curvature radius of the predicted track of the self-vehicle, the prediction accuracy of the predicted track of the peripheral vehicle, and a curvature radius of the predicted track of the peripheral vehicle.

3. The driving assistance device according to claim 2, wherein
in a case where the peripheral vehicle exists within a first range ahead of the self-vehicle and the prediction accuracy of the predicted track of the self-vehicle is equal to or higher than threshold accuracy,
when the curvature radius of the predicted track of the self-vehicle is equal to or larger than a threshold radius, the prediction unit determines a distance between a straight traveling track of the self-vehicle and the peripheral vehicle as the evaluation distance, and
when the curvature radius of the predicted track of the self-vehicle is less than the threshold radius, the prediction unit determines a distance between the predicted track of the self-vehicle and the peripheral vehicle as the evaluation distance.

4. The driving assistance device according to claim 3, wherein
in a case where the peripheral vehicle exists within the first range ahead of the self-vehicle, the prediction accuracy of the predicted track of the self-vehicle is less than the threshold accuracy, and the prediction accuracy of the predicted track of the peripheral vehicle is equal to or higher than the threshold accuracy,
when the curvature radius of the predicted track of the peripheral vehicle is equal to or larger than the threshold radius, the prediction unit determines a distance between a straight traveling track of the self-vehicle and the peripheral vehicle as the evaluation distance, and
when the curvature radius of the predicted track of the peripheral vehicle is less than the threshold radius, the prediction unit determines a distance between the predicted track of the peripheral vehicle and the self-vehicle as the evaluation distance.

5. The driving assistance device according to claim 4, wherein
the prediction unit predicts that there is no possibility of collision between the self-vehicle and the peripheral vehicle when the peripheral vehicle exists within the first range ahead of the self-vehicle, the prediction accuracy of the predicted track of the self-vehicle is less than the threshold accuracy, and the prediction accuracy of the predicted track of the peripheral vehicle is less than the threshold accuracy.

6. The driving assistance device according to claim 1, wherein
in a case where the peripheral vehicle exists within a second range on a side of the self-vehicle,
when prediction accuracy of the predicted track of the self-vehicle is equal to or higher than threshold accuracy and a curvature radius of the predicted track of the self-vehicle is equal to or larger than a threshold radius, the prediction unit determines an intersection of a straight traveling track of the self-vehicle and a straight traveling track of the peripheral vehicle as a predicted intersection,
when the prediction accuracy of the predicted track of the self-vehicle is equal to or higher than the threshold accuracy and the curvature radius of the predicted track of the self-vehicle is less than the threshold radius, the prediction unit determines an intersection of the predicted track of the self-vehicle and the straight traveling track of the peripheral vehicle as the predicted intersection,
when the prediction accuracy of the predicted track of the self-vehicle is less than the threshold accuracy, prediction accuracy of the predicted track of the peripheral vehicle is equal to or higher than the threshold accuracy, and a curvature radius of the predicted track of the peripheral vehicle is equal to or larger than the threshold radius, the prediction unit determines the intersection of the straight traveling track of the self-vehicle and the straight traveling track of the peripheral vehicle as the predicted intersection,
when the prediction accuracy of the predicted track of the self-vehicle is less than the threshold accuracy, the prediction accuracy of the predicted track of the peripheral vehicle is equal to or higher than the threshold accuracy, and the curvature radius of the predicted track of the peripheral vehicle is less than the threshold radius, the prediction unit determines an intersection of the straight traveling track of the self-vehicle and the predicted track of the peripheral vehicle as the predicted intersection, and
the prediction unit determines the evaluation distance based on the predicted intersection and a current position of the self-vehicle.

7. The driving assistance device according to claim 6, wherein
the prediction unit predicts that there is no possibility of collision between the self-vehicle and the peripheral vehicle when the peripheral vehicle exists within the second range on the side of the self-vehicle, the prediction accuracy of the predicted track of the self-vehicle is less than the threshold accuracy, and the prediction accuracy of the predicted track of the peripheral vehicle is less than the threshold accuracy.

8. The driving assistance device according to claim 7, wherein
when the peripheral vehicle exists within the second range on the side of the self-vehicle,
the prediction unit determines an arrival time until the peripheral vehicle arrives at the predicted intersection based on the peripheral vehicle information,
the prediction unit predicts that there is a possibility of collision between the self-vehicle and the peripheral vehicle when the arrival time is equal to or less than a first threshold time, and
the first threshold time is determined based on the vehicle speed of the peripheral vehicle.

9. The driving assistance device according to claim 8, wherein
the prediction unit repeatedly determines the predicted intersection at predetermined time intervals, and
the prediction unit increases the first threshold time when a change amount of a position of the predicted intersection is equal to or larger than a predetermined threshold change amount.

10. The driving assistance device according to claim 1, wherein
the prediction unit repeatedly determines whether or not the peripheral vehicle exists within a first range ahead of the self-vehicle at predetermined time intervals, and
the prediction unit repeatedly determines whether or not the peripheral vehicle exists within a second range on a side of the self-vehicle at predetermined time intervals.

11. The driving assistance device according to claim 1, wherein
the risk position information further includes a traveling track of another vehicle associated with the risk position, and
when the risk position is included within the predetermined distance in a traveling direction of the self-vehicle, the prediction unit predicts a possibility of collision between the self-vehicle and the peripheral vehicle based on the traveling track of another vehicle associated with the risk position and the peripheral vehicle information.

12. The driving assistance device according to claim 1, wherein
the notification unit notifies the occupant using a predetermined notification sound when it is predicted that there is a possibility that the self-vehicle and the peripheral vehicle will collide with each other and the self-vehicle performs a starting operation,
the self-vehicle includes a first display unit and a second display unit provided at a position different from a position of the first display unit, and
the notification unit displays approach information including calling attention to the occupant on the first display unit, and when it is predicted that there is a possibility that the self-vehicle and the peripheral vehicle will collide with each other, the notification unit displays an approach direction of the peripheral vehicle on the second display unit.

13. The driving assistance device according to claim 12, wherein
the prediction unit determines the approach direction of the peripheral vehicle based on a direction of the peripheral vehicle with respect to the self-vehicle and a rotation angle of a course of the peripheral vehicle with respect to a course of the self-vehicle.

14. The driving assistance device according to claim 13, wherein
a first side is one of a right side and a left side which is a side of a road on which passage is mandatory in a region where the self-vehicle is located, and a second side is a side opposite to the first side, and
in a case where it is predicted that there is a possibility that the self-vehicle and the peripheral vehicle will collide with each other,
when the approach direction is within a first range ahead of the self-vehicle and the self-vehicle turns to the second side, the notification unit displays, on the first display unit, that another vehicle approaches from the front of the self-vehicle and displays, on the second display unit, calling attention to the front of the self-vehicle,
when the approach direction is within a second range on the first side of the self-vehicle, the notification unit displays, on the first display unit, that another vehicle approaches from the first side of the self-vehicle, and displays, on the second display unit, calling attention to the first side of the self-vehicle, and
when the approach direction is within a second range on the second side of the self-vehicle, the notification unit displays, on the first display unit, that another vehicle approaches from the second side of the self-vehicle, and displays, on the second display unit, calling attention to the second side of the self-vehicle.

15. A driving assistance method comprising:
storing risk position information indicating a risk position where there is a possibility that a self-vehicle will collide with another vehicle;
acquiring peripheral vehicle information indicating a vehicle speed, a position, a traveling track, and a yaw rate of a peripheral vehicle existing around the self-vehicle from the peripheral vehicle by vehicle-to-vehicle communication;
predicting a possibility of collision between the self-vehicle and the peripheral vehicle based on self-vehicle information indicating a vehicle speed, a position, a traveling track, and a yaw rate of the self-vehicle and the peripheral vehicle information; and
notifying an occupant of the self-vehicle based on a prediction result by the predicting, wherein
in a case where the risk position is not included within a predetermined distance in a traveling direction of the self-vehicle, the predicting includes
determining a predicted track of the self-vehicle based on the self-vehicle information, and determines a predicted track of the peripheral vehicle based on the peripheral vehicle information,
determining an evaluation distance for evaluating an approach situation between the self-vehicle and the peripheral vehicle based on the predicted track of the self-vehicle and the predicted track of the peripheral vehicle, and
predicting that there is no possibility of collision between the self-vehicle and the peripheral vehicle when the evaluation distance is not included in a predetermined range.

16. A non-transitory computer readable storage medium storing a program for causing a computer to execute:
storing risk position information indicating a risk position where there is a possibility that a self-vehicle will collide with another vehicle;
acquiring peripheral vehicle information indicating a vehicle speed, a position, a traveling track, and a yaw rate of a peripheral vehicle existing around the self-vehicle from the peripheral vehicle by vehicle-to-vehicle communication;
predicting a possibility of collision between the self-vehicle and the peripheral vehicle based on self-vehicle information indicating a vehicle speed, a position, a traveling track, and a yaw rate of the self-vehicle and the peripheral vehicle information; and
notifying an occupant of the self-vehicle based on a prediction result by the predicting, wherein
in a case where the risk position is not included within a predetermined distance in a traveling direction of the self-vehicle, the predicting includes
determining a predicted track of the self-vehicle based on the self-vehicle information, and determines a predicted track of the peripheral vehicle based on the peripheral vehicle information,
determining an evaluation distance for evaluating an approach situation between the self-vehicle and the peripheral vehicle based on the predicted track of the self-vehicle and the predicted track of the peripheral vehicle, and
predicting that there is no possibility of collision between the self-vehicle and the peripheral vehicle when the evaluation distance is not included in a predetermined range.
